(19) United States
(12) Patent Application Publication
(10) Pub. No.: US 2025/0138454 A1
(43) Pub. Date: May 1, 2025

(54) IMAGE FORMING METHOD AND IMAGE FORMING SYSTEM

(71) Applicant: KONICA MINOLTA, INC., Tokyo (JP)

(72) Inventors: Kazumi OURA, Sagamihara-shi (JP); Tomoko MINE, Tokyo (JP)

(73) Assignee: KONICA MINOLTA, INC., Tokyo (JP)

(21) Appl. No.: 18/919,665

(22) Filed: Oct. 18, 2024

(30) Foreign Application Priority Data
Oct. 27, 2023 (JP) 2023-184416
Mar. 28, 2024 (JP) 2024-053016

(51) Int. Cl. G03G 15/20; G03G 9/08

(52) U.S. Cl. CPC G03G 15/2017; G03G 9/08; G03G 15/2064; G03G 2215/0604

(57) ABSTRACT

An image forming method that uses an electrostatic charge image development toner containing a toner particle, the image forming method includes, bringing a first fixer into contact with a recording medium on which a toner image containing the electrostatic charge image development toner is formed and fixing the toner image on the recording medium; and cooling the recording medium by bringing a first cooler into contact with the recording medium separated from the first fixer. The toner particle includes an amorphous polyester and a crystalline polyester. A content of a structural unit derived from a bisphenol A derivative is 30 mol % or less based on 100 mol % of all structural units derived from polyhydric alcohols in the amorphous polyester.

### BACKGROUND OF THE INVENTION

### Technical Field

The present invention relates to an image forming method and an image forming system. More specifically, the present invention relates to an image forming method and an image forming system that can form an image having high low-temperature fixing ability of an electrostatic charge image development toner and a wide color gamut.

### Description of Related Art

Print-on-demand has become increasingly popular in recent years because of excellent convenience and rapidity of data processing. In the print-on-demand field, there is a demand for coping with further energy saving and speed-up and providing an image with higher customer satisfaction. Therefore, improvement in low-temperature fixing ability of the electrostatic charge image development toner (hereinafter, also simply referred to as a “toner”) and expansion of a color gamut of an image have been required.

In order to improve the low-temperature fixing ability of the toner, it is necessary to lower a melting temperature and melting viscosity of a binder resin. A toner has been proposed that has improved low-temperature fixing ability through addition of a crystalline resin, such as a crystalline polyester, as a plasticizer (fixing aid).

Amorphous polyester is widely used as the binder resin. From the viewpoint of achieving both low-temperature fixing ability and heat-resistant storage property, a bisphenol-A derivative is suitably used as an alcohol component of the amorphous polyester (see Japanese Unexamined Patent Publication No. 2016-66018). However, since an amorphous polyester having a structural unit derived from a bisphenol A derivative has a rigid molecular structure, its low-temperature fixing ability has not been sufficient. The invention described in Japanese Unexamined Patent Publication No. 2017-062344 improves the low-temperature fixing ability of the toner by using an amorphous polyester that does not have a structural unit derived from a bisphenol-A derivative. However, the above-described technology has room for further study from the viewpoint of expanding the color gamut of the image.

### SUMMARY OF THE INVENTION

The present invention has been made in view of the above-mentioned situations. A problem to be solved by the present invention is to provide an image forming method and an image forming system that can form an image having high low-temperature fixing ability in the electrostatic charge image development toner and a wide color gamut.

In order to solve the above problem, the present inventors have studied the cause of the above problem and the like. As a result, the present inventors have found that the above problems can be solved by setting the content of the structural unit derived from a bisphenol A derivative to 30 mol % or less based on 100 mol % of all the structural units derived from polyhydric alcohols in the amorphous polyester, and further cooling the recording medium by bringing a cooling member into contact with a recording medium separated from the fixing member in the cooling step, and thus have completed the present invention.

That is, the objects according to the present invention described above are achieved by the following means.

According to one aspect of the present invention, an image forming method that uses an electrostatic charge image development toner containing a toner particle, the image forming method including: bringing a first fixer into contact with a recording medium on which a toner image containing the electrostatic charge image development toner is formed and fixing the toner image on the recording medium; and cooling the recording medium by bringing a first cooler into contact with the recording medium separated from the first fixer, wherein the toner particle includes an amorphous polyester and a crystalline polyester, and wherein a content of a structural unit derived from a bisphenol A derivative is 30 mol % or less based on 100 mol % of all structural units derived from polyhydric alcohols in the amorphous polyester.

According to another aspect of the present invention, an image forming system that uses an electrostatic charge image development toner containing a toner particle, the image forming system, including: a fixing unit that brings a first fixer into contact with a recording medium on which a toner image containing the electrostatic charge image development toner is formed and that fixes the toner image on the recording medium; and a cooling unit that cools the recording medium by bringing a first cooling member into contact with the recording medium separated from the first fixing member, wherein the toner particle includes an amorphous polyester and a crystalline polyester, and wherein a content of a structural unit derived from a bisphenol A derivative is 30 mol % or less based on 100 mol % of all structural units derived from polyhydric alcohols in the amorphous polyester.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic diagram of a fixing device 1;

FIG. 2 is a schematic diagram of a fixing device 2;

FIG. 3 is a schematic diagram of a fixing device 3;

FIG. 4 is a schematic diagram of a fixing device 4;

FIG. 5 is a schematic diagram of a cooling device 5;

FIG. 6 is a schematic diagram of a cooling device 6;

FIG. 7A is a schematic diagram of a cooling device 7;

FIG. 7B is a view of the cooling device 7 from above; and

FIG. 8 is a schematic diagram of a fixing and cooling device 8.

### DETAILED DESCRIPTION

Hereinafter, one or more embodiments of the present invention will be described with reference to the drawings. However, the scope of the invention is not limited to the disclosed embodiments.

An image forming method according to the present invention is an image forming method using an electrostatic charge image development toner including toner particles, wherein the toner particles comprise an amorphous polyester and a crystalline polyester, a content of a structural unit derived from a bisphenol A derivative is 30 mol % or less based on 100 mol % of total structural units derived from a polyhydric alcohol in the amorphous polyester, the image forming method including: a fixing step of fixing a toner image on a recording medium by contacting a first fixing member with the recording medium on which a toner image is formed; and a cooling step of cooling the recording medium by contacting a first cooling member with the recording medium separated from the first fixing member.

This feature is a technical feature common to or corresponding to the following embodiments.

In an embodiment of the present invention, the content of the structural unit derived from a bisphenol A derivative is preferably 10 mol % or less based on 100 mol % of all the structural units derived from a polyhydric alcohol in the amorphous polyester. As a result, the low-temperature fixing ability of the toner is further improved, and the color gamut is further expanded.

As an embodiment of the present invention, it is preferable that the first fixing member is a fixing belt, and a fixing pad is further used in the fixing step. Thus, the toner image can be sufficiently heated more easily, and an amount of internally scattered light can be further suppressed. In addition, uniformity of an image surface is easily improved.

In an embodiment of the present invention, in the fixing step, fixing may be performed in one stage. Thus, the fixing process can be performed in a short time. In addition, it is easy to simplify the configuration of the fixing device.

In an embodiment of the present invention, the toner image may be heated a plurality of times in the fixing step. Thus, the toner image can be sufficiently heated more easily, and the amount of internally scattered light can be further suppressed.

In an embodiment of the present invention, the amorphous polyester preferably has a structural unit derived from an aliphatic polyhydric alcohol having 3 to 6 carbon numbers. The structural unit has higher compatibility with the crystalline polyester than a structural unit derived from a bisphenol A derivative. Therefore, the structural unit derived from the aliphatic polyhydric alcohol having 3 to 6 carbon numbers can decrease the degree of crystallinity (proportion of crystalline regions) of the crystalline polyester in the crystalline polyester domains. Thus, the generation of internally scattered light is reduced, and the effect of expanding the color gamut is exhibited. Further, the structural unit is also preferred from the viewpoint of low-temperature fixing ability.

In an embodiment of the present invention, the crystalline polyester preferably includes a structural unit derived from the aliphatic polyhydric alcohol having 6 to 12 carbon numbers and a structural unit derived from the aliphatic polyvalent carboxylic acid having 6 to 12 carbon numbers. When the number of carbon numbers of the structural unit is 12 or less, the polarity of the crystalline polyester increases, and the compatibility between the crystalline polyester and the amorphous polyester increases. Thus, the crystallinity of the crystalline polyester in the inside of the image is lowered. Thus, the generation of internally scattered light is reduced, and the effect of expanding the color gamut is exhibited. Furthermore, when the carbon numbers of the structural unit is 12 or less, the low-temperature fixing ability also becomes satisfactory. When the carbon numbers of the structural unit is 6 or more, the heat-resistant storage property of the toner becomes satisfactory. Therefore, by using the crystalline polyester, it is possible to expand the color gamut and improve the low-temperature fixing ability while ensuring the heat-resistant storage property of the toner.

In an embodiment of the present invention, it is preferable that a second cooling member that sandwiches the recording medium with the first cooling member is further used in the cooling step. By sandwiching the recording medium between the first cooling member and the second cooling member that are in contact with the recording medium, the image cooling rate can be further increased.

An image forming system of the present invention is an image forming system using an electrostatic charge image development toner containing toner particles, wherein the toner particles contain an amorphous polyester and a crystalline polyester, a content of a structural unit derived from a bisphenol A derivative is 30 mol % or less based on 100 mol % of all structural units derived from polyhydric alcohols in the amorphous polyester, and the toner particles contain the electrostatic charge image development toner. The fixing means fixes the toner image on the recording medium by bringing a first fixing member into contact with the recording medium on which the toner image is formed including the electrostatic charge image development toner. The cooling means cools the recording medium by bringing a first cooling member into contact with the recording medium separated from the first fixing member.

Hereinafter, the present invention will be described in detail. In the present description, when two figures are used to indicate a range of value before and after “to”, these figures are included in the range as a lower limit value and an upper limit value.

### [1. Outline of Image Forming Method of Present Invention]

The image forming method of the present invention is an image forming method using an electrostatic charge image development toner containing toner particles. The toner particles contain an amorphous polyester and a crystalline polyester. A content of an structural unit derived from a bisphenol A derivative is 30 mol % or less based on 100 mol % of all structural units derived from polyhydric alcohols in the amorphous polyester. The image forming method includes a fixing process and a cooling process. In the fixing process, a first fixing member is brought into contact with a recording medium on which a toner image containing the electrostatic charge image development toner has been formed, to fix the toner image on the recording medium. In the cooling step, the first cooling member is brought into contact with the recording medium separated from the first fixing member to cool the recording medium.

The image forming method of the present invention may include other steps, for example, a toner image forming step of forming an unfixed toner image before the fixing step.

### [2. Electrostatic Charge Image Development Toner]

In the present invention, the “electrostatic charge image development toner” refers to an aggregate of toner particles. Hereinafter, the “electrostatic charge image development toner” is also referred to simply as the “toner”.

The toner particles may be formed of only toner base particles, or may be formed of toner base particles and an external additive to be adhered to surfaces of the toner base particles. The “toner base particles” are particles constituting a base of toner particles. The toner base particles contain a binder resin such as amorphous polyester, and may further contain, for example, a coloring agent, a release agent (wax), and a charge control agent, if necessary.

The toner particles according to the present invention contains an amorphous polyester and a crystalline polyester. Specifically, toner base particles constituting the toner particles contain an amorphous polyester and a crystalline polyester.

### [2-1. Amorphous Polyester]

The amorphous polyester is a polyester exhibiting an amorphous property among polyesters obtained by a polymerization reaction of a carboxylic acid having a valency of 2 or more (polyvalent carboxylic acid) and an alcohol having a valency of 2 or more (polyhydric alcohol).

The term “amorphous” means not having a melting point. In other words, the term “amorphous” means that this does not have a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min.

The amorphous polyester can be synthesized, for example, by esterification through polycondensation of a polyvalent carboxylic acid and a polyhydric alcohol with the use of a known esterification catalyst.

In the present invention, the content of the structural unit derived from the bisphenol A derivative (BPAD) based on 100 mol % of the structural unit derived from all polyhydric alcohols in amorphous polyester (APEs) is also referred to as the “BPAD content in APEs”.

The content of BPAD in APEs in the present invention is 30 mol % or less. The content of BPAD in APEs is preferably 10 mol % or less, and more preferably 0 mol %, from the viewpoint of color gamut and low-temperature fixing ability.

The bisphenol A derivatives include bisphenol A and derivatives thereof. Examples of the bisphenol A derivative include bisphenol A, an ethylene oxide adduct of bisphenol A, and a propylene oxide adduct of bisphenol A. In the present invention, phenols such as bisphenol A are also included in the alcohol. This is a definition based on the viewpoint that phenols such as bisphenol A can also be esterified in the same manner as alcohols.

Examples of polyhydric alcohols other than bisphenol A derivatives that can be used for synthesis of the amorphous polyester include, as dihydric or trihydric alcohols, ethyleneglycol, propyleneglycol, 1,4-butanediol, 2,3-butanediol, diethylene glycol, triethylene glycol, 1,5-pentanediol, 1,6-hexanediol, neopentyl glycol, 1,4-cyclohexanedimethanol, dipropylene glycol, polyethylene glycol, polypropylene glycol, glycerin, sorbitol, 1,4-sorbitan, and trimethylolpropane. The polyhydric alcohols may be used alone or in combination of two or more thereof.

The amorphous polyester preferably has a structural unit derived from an aliphatic polyhydric alcohol having 3 to 6 carbon numbers. The structural unit has higher compatibility with the crystalline polyester than the structural unit derived from the bisphenol A derivative. Therefore, the structural unit derived from the aliphatic polyhydric alcohol having 3 to 6 carbon numbers can decrease the degree of crystallinity (proportion of crystalline regions) of the crystalline polyester in the crystalline polyester domains. Thus, the generation of internally scattered light is reduced, and the effect of expanding the color gamut is exhibited. Further, the structural unit is also preferred from the viewpoint of low-temperature fixing ability.

For these reasons, the aliphatic polyhydric alcohol having 3 to 6 carbon numbers is preferably used in the synthesis of the amorphous polyester.

Examples of polyvalent carboxylic acids that can be used in the synthesis of the amorphous polyester include phthalic acids, isophthalic acids, terephthalic acids, trimellitic acids, naphthalene 2,6-dicarboxylic acids, malonic acids, mesaconic acids, dimethyl isophthalate, fumaric acids, dodecenyl succinic acids, and 1-,-10-dodecane dicarboxylic acids. The polyvalent carboxylic acid may be used alone or in combination of two or more kinds thereof.

Examples of catalysts that can be used in the synthesis of the amorphous polyester include metal-containing compounds, phosphite compounds, phosphate compounds, and amine compounds. Examples of the metal contained in the metal-containing compound include sodium, lithium, magnesium, calcium, aluminum, zinc, manganese, antimony, titanium, tin, zirconium, and germanium. These may be used alone or in combination of two or more kinds thereof.

The polymerization temperature is not particularly limited, but is preferably in a range of 150 to 250° C. The polymerization time is not particularly limited, but is preferably in a range of 0.5 to 10 hours. During the polymerization, the pressure in the reaction system may be reduced as necessary.

The glass transition point Tg of the amorphous polyester is preferably in a range of 25 to 60° C., and more preferably in a range of 35 to 55° C., from the viewpoint of achieving both sufficient low-temperature fixing ability and heat resistant storage property. The glass transition point Tg can be measured using a differential scanning calorimeter, for example, Diamond DSC (manufactured by PerkinElmer, Inc.). To be specific, the sample 3.0 mg is sealed in an aluminum pan, and the temperature is changed in the order of heating, cooling, and heating. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for 1 minute. The baseline shift in the measurement curve obtained on the second heating is determined. The intersection of an extended line of the baseline before the shift and a tangent line indicating the maximum inclination of the shifted portion of the baseline is defined as the glass transition point Tg. An empty aluminum pan is used for a reference.

The weight mean molecular weight Mw of the amorphous polyester may be in the range of 10,000 to 100,000. The weight mean molecular weight Mw can be measured by gel permeation chromatography (GPC).

The amorphous polyester may be a hybrid amorphous polyester having a graft copolymer structure of an amorphous polyester polymerized segment and a styrene-acrylic polymerized segment.

The content of the amorphous polyester in the toner base particles is preferably 20% by mass or more, and more preferably 50% by mass or more, from the viewpoint of low-temperature fixing ability.

### (Analysis Method for Constituent Components of Amorphous Polyester)

For analysis of the constituent components of the polyester, pretreatment involving chemical decomposition is effective. Although there are various types of chemical decomposition, methods effective for composition analysis of polyester as a condensation resin are, for example, alkaline hydrolysis and supercritical methanol decomposition.

Examples of the method for alkaline hydrolysis include the following methods. The toner and a hydrolysis liquid (alkaline agent, moisture, and organic solvents) are placed in a high-pressure wet decomposition crucible, and are heated in an oven at 80 to 150° C. for 3 hours. The oven temperature and heating time may be changed depending on the composition of the sample. The alkaline agent is, for example, sodium hydroxide or potassium hydroxide. The organic solvent is, for example, methanol or DMSO (dimethyl sulfoxide). As the container, a small autoclave may be used.

The molar ratios of the respective constituent components can be calculated from peaks derived from the bisphenol-A derivative and peaks derived from the other polyhydric alcohol in a proton nuclear magnetic resonance (1H-NMR) spectrum of a decomposition liquid after the hydrolysis of the toner. When the molar ratios of the respective constituent components cannot be calculated from the 1H-NMR spectrum due to the influence of matrix components, the composition of the polyhydric alcohol can also be analyzed from the GC chromatograms of the decomposition liquid. The BPAD content in APEs can be calculated by the above-described method. The molar ratio of the carboxylic acid can be similarly analyzed by subjecting the decomposition liquid to derivatization treatment.

The method for measuring the carbon numbers and the content (proportion) of the constituent components (constituent units) of the polyester is as described above. These can be identified by pyrolysis gas chromatography/mass spectrometry (GC/MS) in addition to 1H-NMR measurement.

### [2-2. Crystalline Polyester]

The crystalline polyester is a polyester exhibiting crystallinity among polyesters obtained by a polymerization reaction of a carboxylic acid having a valency of 2 or more (polyvalent carboxylic acid) and an alcohol having a valency of 2 or more (polyhydric alcohol).

The term “crystalline” means having a melting point. In other words, the term “crystalline” refers to having a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min.

The melting point Tm of the crystalline polyester is preferably 75° C. or lower. The melting point Tm is the temperature of the peak top of an endothermic peak, and can be measured using a differential scanning calorimeter, for example, Diamond DSC (manufactured by PerkinElmer, Inc.). A specific measurement sequence is as follows. The sample 0.5 mg is sealed in an aluminum KITNO.B0143013, and the temperature is changed in the order of heating, cooling, and heating. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for 1 minute. The peak top temperature of the endothermic peak in the endothermic curve obtained during the second heating is taken as the melting point Tm. An empty aluminum pan is used for a reference.

The crystalline polyester can be produced by esterification through polycondensation of a polyvalent carboxylic acid and a polyhydric alcohol using a known esterification catalyst.

Examples of divalent polyvalent carboxylic acids that can be used in the synthesis of the crystalline polyester include saturated aliphatic dicarboxylic acids, unsaturated aliphatic dicarboxylic acids, and unsaturated aromatic dicarboxylic acids. Examples of saturated aliphatic dicarboxylic acids include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid and the like. Examples of the unsaturated aliphatic dicarboxylic acid include methylenesuccinic acid, fumaric acid, maleic acid, 3-hexenedioic acid, 3-octenedioic acid, and dodecenylsuccinic acid. Examples of the unsaturated aromatic dicarboxylic acids include phthalic, terephthalic, isophthalic, t-butylisophthalic, tetrachlorophthalic, chlorophthalic, nitrophthalic, p-phenylenediacetic, 2,6-naphthalenedicarboxylic, 4,4′-biphenyldicarboxylic, and anthracenedicarboxylic acids, and the like. Lower alkyl esters and acid anhydrides of these dicarboxylic acids can also be used as the polyvalent carboxylic acid.

Examples of the trivalent or higher polyvalent carboxylic acid that can be used in the synthesis of the crystalline polyester include trimellitic acid and pyromellitic acid. The polyvalent carboxylic acid may be used alone or in combination of two or more kinds thereof.

Examples of dihydric polyhydric alcohols usable for synthesis of the crystalline polyester include saturated aliphatic diols, unsaturated aliphatic diols, and aromatic diols. Examples of saturated aliphatic diols include ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, neopentyl glycol, and the like. Examples of the unsaturated aliphatic diol include 2-butene-1,4-diol, 3-butene-1,4-diol, 2-butyne-1,4-diol, 3-butyne-1,4-diol, and 9-octadecene-7,12-diol. Examples of the aromatic diol include bisphenols and alkylene oxide adducts of bisphenols. Examples of the bisphenols include bisphenol A and bisphenol F. Examples of the alkylene oxide adducts of bisphenols include ethylene oxide adducts of bisphenols and propylene oxide adducts of bisphenols. Derivatives of these diols can also be used as the polyhydric alcohol. The polyhydric alcohols may be used alone or in combination of two or more thereof.

The crystalline polyester preferably includes a structural unit derived from the aliphatic polyhydric alcohol having 6 to 12 carbon numbers and a structural unit derived from the aliphatic polyvalent carboxylic acid having 6 to 12 carbon numbers. When the number of carbon numbers of the structural unit is 12 or less, the polarity of the crystalline polyester increases, and the compatibility between the crystalline polyester and the amorphous polyester increases. Thus, the crystallinity of the crystalline polyester in the inside of the image is lowered. Thus, the generation of internally scattered light is reduced, and the effect of expanding the color gamut is exhibited. Furthermore, when the carbon numbers of the structural unit is 12 or less, the low-temperature fixing ability also becomes satisfactory. When the carbon numbers of the structural unit is 6 or more, the heat-resistant storage property of the toner becomes satisfactory. Therefore, by using the crystalline polyester, it is possible to expand the color gamut and improve the low-temperature fixing ability while ensuring the heat-resistant storage property of the toner.

For these reasons, the aliphatic polyhydric alcohol having 6 to 12 carbon numbers and the aliphatic polycarboxylic acid having 6 to 12 carbon numbers are preferably used in the synthesis of the crystalline polyester.

For synthesis of the crystalline polyester, any of the catalysts usable for synthesis of the amorphous polyester described above can be used.

The polymerization temperature is not particularly limited, but is preferably in a range of 70 to 250° C. The polymerization time is not particularly limited, but is preferably in a range of 0.5 to 10 hours. During the polymerization, the pressure in the reaction system may be reduced as necessary.

The crystalline polyester may be a hybrid crystalline polyester having a graft copolymer structure of a crystalline polyester polymerized segment and a styrene-acrylic polymerized segment.

The weight mean molecular weight Mw of the crystalline polyester is preferably within a range of 1000 to 29000. The weight mean molecular weight Mw can be measured by gel permeation chromatography (GPC).

The content of the crystalline polyester is preferably in a range of 1 to 20% by mass and more preferably in a range of 3 to 15% by mass with respect to the total amount of the resins contained in the toner base particles.

### (Method for Analyzing Constituent Components of Crystalline Polyester)

The structure and content (proportion) of the constituent components (constituent units) of the crystalline polyester can be analyzed by a method similar to the method of analyzing the constituent components of the amorphous polyester described above.

### [2-3. Vinyl Resin]

The toner particle according to the present invention may contain a vinyl-based resin.

The vinyl-based resin refers to a polymer of a monomer having a vinyl group (hereinafter, referred to as a vinyl monomer), which is amorphous.

Examples of the vinyl-based resin that can be used include a styrene-acrylic resin, a styrene resin, and an acrylic resin, and among these, a styrene-acrylic resin excellent in heat resistance is preferable.

Examples of the vinyl monomer that can be used include the following, and one of these may be used alone, or two or more may be used in combination.

### (1) Styrene-Based Monomer

Examples thereof include monomers having a styrene structure, such as styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and derivatives thereof.

### (2) (Meth) Acrylic Acid Ester Monomer

Examples thereof include monomers having a (meth) acrylic group, such as methyl (meth) acrylate, ethyl (meth) acrylate, n-butyl (meth) acrylate, isopropyl (meth) acrylate, isobutyl (meth) acrylate, t-butyl (meth) acrylate, n-octyl (meth) acrylate, 2-ethylhexyl (meth) acrylate, stearyl (meth) acrylate, lauryl (meth) acrylate, phenyl (meth) acrylate, diethylaminoethyl (meth) acrylate, dimethylaminoethyl (meth) acrylate, and derivatives thereof.

### (3) Vinyl Esters

vinyl propionate, vinyl acetate, vinyl benzoate, and the like

### (4) Vinyl Ethers

vinyl methyl ether, vinyl ethyl ether, etc

### (5) Vinyl Ketones

vinyl methyl ketone, vinyl ethyl ketone, vinyl hexyl ketone, etc

### (6) N-Vinyl Compounds

N-vinylcarbazole, N-vinylindole, N-vinylpyrrolidone, and the like

### (7) Others

Examples thereof include vinyl compounds such as vinylnaphthalene and vinylpyridine, and acrylic acid and methacrylic acid derivatives such as acrylonitrile, methacrylonitrile, and acrylamide.

As the vinyl monomer, a monomer having an ionic dissociable group such as a carboxy group, a sulfonic acid group and a phosphate group is preferable, since control of the affinity with the crystalline resin becomes easy.

Examples of the monomer having a carboxy group include acrylic acid, methacrylic acid, maleic acid, itaconic acid, cinnamic acid, fumaric acid, maleic acid monoalkyl ester, and itaconic acid monoalkyl ester.

Examples of the monomer having a sulfonic acid group include styrenesulfonic acid, allylsulfosuccinic acid, and 2-acrylamido-2-methylpropanesulfonic acid.

Examples of the monomer having a phosphate group include acidophosphooxyethyl methacrylate.

A polymer having a crosslinked structure can also be obtained by using polyfunctional vinyls as the vinyl monomer. Examples of the polyfunctional vinyls include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, and neopentyl glycol diacrylate.

### [2-4. Release Agent]

The toner particle according to the present invention preferably contains a release agent.

The release agent is not particularly limited, and various known waxes can be used.

Examples of the release agent that can be used include branched-chain hydrocarbon waxes, long-chain hydrocarbon-based waxes, dialkyl ketone-based waxes, ester-based waxes, and amide-based waxes. Examples of the branched chain hydrocarbon wax include polyolefin waxes such as polyethylene wax and polypropylene wax, and microcrystalline waxes. Examples of the long-chain hydrocarbon-based wax include paraffin wax, Fischer-Tropsch wax, and Sasol wax. Examples of the dialkyl ketone-based wax include distearyl ketone. Examples of the ester-based wax include carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, distearyl maleate, and stearyl stearate. Examples of the amide-based wax include ethylenediamine behenylamide and trimellitic acid tristearylamide.

These release agents may be used alone or in combination of two or more kinds thereof.

The melting point Tm of the release agent is preferably 50° C. or more and 100° C. or less. When the melting point Tm is 100° C. or lower, the release agent is easily melted at the time of fixing, and the separability from the fixing member becomes satisfactory. When the melting point Tm is 50° C. or higher, the release agent is unlikely to volatilize during fixing and is unlikely to be micronized, which is preferable in terms of environmental load.

The melting point Tm is a peak top temperature of an endothermic peak, and can be measured by DSC. A specific measurement sequence is as follows. The sample 0.5 mg is sealed in an aluminum pan, and the temperature is changed in the order of heating, cooling, and heating. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for 1 minute. The peak top temperature of the endothermic peak in the endothermic curve obtained during the second heating is taken as the melting point Tm. In a case where a plurality of endothermic peaks is detected, the peak top temperature of the peak on the highest temperature side among the endothermic peaks is defined as the melting point Tm of the release agent. An empty aluminum pan is used for a reference.

The content of the release agent is preferably in a range of 1 to 20% by mass and more preferably in a range of 3 to 18% by mass relative to the total amount of resins contained in the toner base particles. When the content of the release agent is within the above range, sufficient fixing separability can be obtained.

### [2-5. Coloring Agent]

The toner particle according to the present invention may contain a coloring agent.

As the coloring agent, a known inorganic coloring agent or organic coloring agent can be used. As the coloring agent, carbon black, magnetic powder, an organic pigment, an inorganic pigment, a dye, or the like can be used.

Examples of a colorant for obtaining a black toner include carbon blacks such as furnace black and channel black; magnetic materials such as magnetite and ferrite; dyes; and inorganic pigments including nonmagnetic iron oxide. Examples of the colorant for obtaining a color toner include known dyes and organic pigments.

Examples of the organic pigments include C.I. Pigment Reds 5, 48:1, 53:1, 57:1, 81:4, 122, 139, 144, 149, 166, 177, 178, 222, 238, and 269, C.I. Pigment Yellows 14, 17, 74, 93, 94, 138, 155, 180, and 185, C.I. Pigment Oranges 31, and 43, C.I. Pigment Blue 15:3, 60, and 76, and the like.

Examples of the dyes include C.I. Solvent Reds 1, 49, 52, 58, 68, 11, and 122, C.I. Solvent Yellows 19, 44, 77, 79, 81, 82, 93, 98, 103, 104, 112, and 162, C.I. Solvent Blues 25, 36, 69, 70, 93, and 95, and the like.

The colorant for obtaining the toner of each color may be contained alone or in combination of two or more kinds for each color.

The content of the coloring agent is preferably from 1 to 30% by mass, more preferably from 2 to 20% by mass, relative to the toner particles.

### [2-6. Charge Control Agent]

The toner particles according to the present invention may contain a charge control agent.

As the charge control agent, for example, known compounds such as nigrosine dyes, metal salts of naphthenic acid, metal salts of higher fatty acids, alkoxylated amines, quaternary ammonium salts, azo metal complexes, and metal salts of salicylic acid can be used. By using the charge control agent, a toner having excellent chargeability can be obtained.

The content of the charge control agent can be usually within a range of 0.1 to 5.0% by mass with respect to the total amount of the resin contained in the toner base particles.

### [2-7. External Additives]

The toner particle according to the present invention preferably includes an external additive.

Examples of the external additive include inorganic oxide fine particles, inorganic stearic acid compound fine particles, inorganic titanic acid compound fine particles, and zirconia particles. These external additives may be used alone or in combination with two or more types.

Examples of the inorganic oxide fine particles include silica particles, alumina fine particles, titanium oxide fine particles, zinc oxide particles, chromium oxide particles, cerium oxide particles, antimony oxide particles, tungsten oxide particles, tin oxide particles, tellurium oxide particles, manganese oxide particles, and boron oxide particles. The particles containing these inorganic materials as a main component may be subjected to a hydrophobic treatment with a surface treatment agent such as a silane coupling agent or silicone oil, if necessary. The number-average primary particle size of these particles is preferably in a range of 20 to 200 nm, more preferably in a range of 30 to 150 nm.

The external additive may be a lubricant, such as a metal salt of a higher fatty acid. Examples of the higher fatty acid include stearic acid, oleic acid, palmitic acid, linoleic acid, and ricinoleic acid. Examples of the metal constituting the metal salt include zinc, manganese, aluminum, iron, copper, magnesium, calcium and the like.

Examples of the inorganic titanate compound fine particles include strontium titanate and zinc titanate.

These external additives may be used alone or in combination of two or more.

The amount of the external additive to be added is preferably in a range of 0.05 to 5% by mass, more preferably in a range of 0.1 to 3% by mass relative to the total amount of the toner base particles. When a plurality of external additives are used, the addition amount is the total addition amount thereof.

Among these, the toner particle of the present invention preferably has a silica particle or a strontium titanate particle as the external additive.

### (Silica Particles)

The silica particles are particles containing silica (SiO₂) as a main component. The silica particles may be either crystalline or amorphous. The silica particles may be particles produced using, as a raw material, a silicon compound such as water glass or alkoxysilane, or particles obtained by grinding quartz.

The silica particles may be, for example, sol-gel silica particles, aqueous colloidal silica particles, alcoholic silica particles, fumed silica particles obtained by a gas-phase method or the like, and fused silica particles. Of the foregoing, the silica particles are preferably sol-gel silica particles.

The sol-gel silica particles are obtained, for example, as follows. Tetraalkoxysilane (TMOS or the like) is added dropwise to an alkali catalyst solution containing an alcohol compound and ammonia water, and the tetraalkoxysilane is hydrolyzed and condensed to obtain a suspension containing sol-gel silica particles. Next, the solvent is removed from the suspension to obtain a granular material. Next, the granular material is dried, thereby obtaining sol-gel silica particles.

The silica particles may be silica particles hydrophobized with a hydrophobizing agent. Examples of the hydrophobizing agent include known organic silicon compounds having an alkyl group (for example, a methyl group, an ethyl group, a propyl group, or a butyl group). Specific examples of the hydrophobizing agent include an alkoxysilane compound, a siloxane compound, and a silazane compound. Of the foregoing, the hydrophobizing agent is preferably at least one of a siloxane compound and a silazane compound. Examples of the siloxane compound include silicone oil and silicone resin. The silicone oil is preferably dimethyl silicone oil. Examples of the silazane compound include hexamethyldisilazane, tetramethyldisilazane, and the like. The silazane compound is preferably hexamethyldisilazane (HMDS). The hydrophobizing agents can be used alone or in combination of two or more kinds thereof.

The amount of the hydrophobizing agent, such as a silazane compound, adhered to the surface of the silica particles is preferably in a range of 0.01 to 5% by mass, more preferably in a range of 0.05 to 3% by mass, and even more preferably in a range of 0.10 to 2% by mass, relative to the silica particles, from the viewpoint of improving the degree of hydrophobization of the silica particles.

Examples of the method of subjecting the silica particles to the hydrophobic treatment with the hydrophobic treatment agent include the following methods.
(1) A method in which a hydrophobizing agent is dissolved in supercritical carbon dioxide and the solution is applied to the surface of the silica particle.
(2) A method in which a solution containing a hydrophobizing agent is applied (e.g., sprayed or coated) to the surface of silica particles in the air.
(3) A method in which a solution containing a hydrophobizing agent is added to a silica particle dispersion liquid in the atmosphere and held, and then the mixed liquid is dried.

The number-average particle size of the silica particles is preferably 90 nm or more and 130 nm or less. When the number average particle diameter is 90 nm or more, the silica particles tend to exhibit a spacer effect with other toner particles. Thus, even when the toner base particles have high meltability, the toner particles are unlikely to coalesce and aggregate with each other and the heat resistant storage property is improved. When the number mean particle diameter is 130 nm or less, the silica particles are less likely to be detached from the toner base particles, and thus a decrease in heat resistant storage property due to exposure of the toner base particles can be suppressed.

The number mean particle diameter of the silica particles is determined by the following procedure.
(1) The toner particles are dispersed in methanol, and the mixture is stirred at room temperature (23° C.) and treated in an ultrasonic bath to separate the external additive from the toner base particles. The toner base particles are precipitated by centrifugation, and a dispersion liquid in which the external additive is dispersed is collected. The methanol is distilled off from the dispersion liquid, and the external additive is removed.
(2) The external additive taken out is dispersed in resin particles (polyester, weight mean molecular weight Mw=50000) having a volume mean particle diameter of 100 μm.
(3) An image of the polymer particles in which the external additive is dispersed is captured at a magnification of 40,000 times using a scanning electron microscopy (SEM, S-4800, manufactured by Hitachi High-Technologies Corporation) equipped with an energy dispersive X-ray spectrometer (EDX apparatus, manufactured by Horiba, Ltd., EMAX Evolution X-Max 80 mm²). At this time, 300 or more primary particles of silica are specified from one visual field based on the presence of Si by EDX analysis. The SEM observation is performed with an acceleration voltage of 15 kV and an emission current of 20 μA at WD15 mm. The EDX analysis is performed under the same conditions for a detection time of 60 minutes.
(4) The obtained image is loaded into an image analyzing device (LUZEXIII, manufactured by Nireco Corporation). The area of each particle is obtained by analyzing the captured image.
(5) From the measured area value, the particle diameter of the silica particles is determined as a circle-equivalent diameter.
(6) 100 silica particles having equivalent circle diameters of 80 nm or more are selected.
(7) The number mean particle diameter is calculated from the particle diameters of the selected silica particles.

### (Strontium Titanate Particle)

The strontium titanate particles are particles containing strontium titanate (SrTiO₃) as a main component. Since the strontium titanate particle has a rectangular parallelepiped shape having a sharp edge, it is effective in fixing separability.

The number-average primary particle size of the strontium titanate particles is preferably 20 to 200 nm and more preferably 30 to 150 nm.

The content of the strontium titanate particles is preferably 0.05 to 2.0% by mass and more preferably 0.1 to 1.0% by mass with respect to the toner base particles. Thus, a satisfactory polishing effect can be obtained while maintaining toner fluidity.

The strontium titanate particles can be obtained by, for example, a normal pressure heating reaction method. A specific method of the normal pressure heating reaction method is exemplified below.

As a titanium oxide source, a mineral acid-peptized product of a hydrolysate of a titanium compound can be used. The titanium oxide source is preferably metatitanic acid obtained by a sulfuric acid method and having a SO₃ content of 1.0% by mass or less, preferably 0.5% by mass or less, which is deflocculated by adjusting the pH to 0.8 to 1.5 with hydrochloric acid.

As the strontium oxide source, nitrates, hydrochlorides, and the like of metals can be used, and for example, strontium nitrate, strontium chloride, and the like can be used.

As the aqueous alkali solution, a caustic alkali can be used, and among them, an aqueous sodium hydroxide solution is preferable.

In the method of producing the strontium titanate particles, for example, the following factors affect the particle size. These can be appropriately adjusted in order to obtain an intended particle size and particle size distribution.
(1) Mixing ratio of titanium oxide source and strontium oxide source during reaction
(2) Titanium oxide source concentration at initial reaction
(3) Temperature and addition rate when alkaline aqueous solution is added

In order to prevent formation of a carbonate in the reaction process, it is preferable to prevent intrusion of carbon dioxide gas, for example, by performing the reaction under a nitrogen gas atmosphere.

The mixing ratio of the titanium dioxide source and the strontium oxide source is preferably 0.90 to 1.40, more preferably 1.05 to 1.20, in terms of SrO/TiO₂ molar ratio. Within the above range, unreacted titanium oxide is less likely to remain. The concentration of the titanium dioxide source at the initial stage is preferably 0.05 to 1. 3 mol/L, more preferably 0.08 to 1.0 mol/L, when the titanium dioxide source is TiO₂.

The temperature at which the alkaline aqueous solution is added is preferably 60 to 100° C. As the addition rate of the alkaline aqueous solution is lower, strontium titanate particles having a larger particle diameter are obtained. As the addition rate of the alkaline aqueous solution is higher, strontium titanate particles having a smaller particle size are obtained. The addition rate of the alkaline aqueous solution is preferably 0.001 to 1.2 equivalent weight/h, more preferably 0.002 to 1.1 equivalent weight/h, relative to the fed raw material. The addition rate of the alkaline aqueous solution can be appropriately adjusted according to the particle size to be obtained.

The strontium titanate particles obtained by the normal-pressure heating reaction are preferably further subjected to an acid treatment. When the mixing ratio of the titanium dioxide source and the strontium oxide source is more than 1.0 in terms of SrO/TiO₂ molar ratio, unreacted metallic sources other than titanium remain after completion of the reactions. The residue may react with carbon dioxide gas in the air to produce impurities such as metal carbonate. When impurities such as a metal carbonate remain on the surface, an organic surface treatment agent cannot be uniformly coated due to the influence of the impurities at the time of organic surface treatment for imparting hydrophobicity. Therefore, after the addition of the alkaline aqueous solution, an acid treatment is preferably performed in order to remove the unreacted metal source. In the acid treatment, hydrochloric acid is preferably used. The pH after the adjustment is preferably 2.5 to 7.0, more preferably 4.5 to 6.0. As the acid, in addition to hydrochloric acid, nitric acid, acetic acid, and the like can be used.

### [2-8. Method for Producing Toner]

The toner can be produced by producing toner base particles and adding an external additive thereto as necessary.

There is no particular limitation on the method for producing the toner base particles, and any known method such as emulsion aggregation, pulverization, and suspension polymerization can be used.

A pulverization method is preferable as a method for producing the toner base particles. The pulverization method includes a step of obtaining a melt-kneaded product and a step of pulverizing the melt-kneaded product to obtain toner particles. In the step of obtaining a melt-kneaded product, a mixture containing the binder resin, a colorant, and if necessary, other components such as a release agent is melt-kneaded.

Hereinafter, a sequence for producing toner base particles using a pulverization method will be described as an example. First, for example, the binder resin and a colorant, and if necessary, other components such as a release agent and a charge control agent as materials to constitute toner base particles are weighed in predetermined amounts, blended, and mixed. Examples of a mixing apparatus include a double-cone mixer, a V-type mixer, a drum-type mixer, a super mixer, a Henschel mixer, a Nauter mixer, and a mechanohybrid.

Next, the mixed material is melted and kneaded. In the melt-kneading step, a batch-type kneader such as a pressure kneader or a Banbury mixer, or a continuous-type kneader can be used. The apparatus used in the melt-kneading step is preferably a single-screw or double-screw extruder because of its superiority in continuous production. Examples of the double-screw extruder include KTK double-screw extruder (manufactured by Kobe Steel, Ltd), TEM double-screw extruder (manufactured by Toshiba Machine Co., Ltd), PCM kneader (manufactured by Ikegai Ironworks Co., Ltd), double-screw extruder (manufactured by K.C. K.K), Co-Kneader (manufactured by Buss), and Kneadex (manufactured by Nippon Coke & Engineering Co., Ltd). The temperature of the melt-kneading is preferably about 100 to 200° C. The resin composition obtained by melt-kneading is rolled with a two roll mill or the like, and quenched with water or the like in a cooling step.

Next, the cooled product of the resin composition is pulverized to a desired particle size in a pulverization step. In the pulverization step, the cooled product of the resin composition is coarsely pulverized and then finely pulverized. Examples of the pulverizer used for the coarse pulverization include a crusher, a hammer mill, and a feather mill. Examples of the pulverizer used for the pulverization include Kryptron System (manufactured by Kawasaki Heavy Industries, Ltd), Super Rotor (manufactured by Nisshin Engineering Inc), Turbo Mill (manufactured by Turbo Kogyo Co., Ltd), and an air-jet pulverizer.

Thereafter, the pulverized product is classified using a classifier and/or a sieving machine, if necessary. As a result, pulverized toner base particles are obtained as a classified product. Examples of the classifier or the sieving machine include an inertial classification type Elbow Jet (manufactured by Nittetsu Mining Co., Ltd), a centrifugal force classification type Turboplex (manufactured by Hosokawa Micron Corporation), a TSP separator (manufactured by Hosokawa Micron Corporation), and Faculty (manufactured by Hosokawa Micron Corporation).

The toner base particles are desirably surface-treated with hot air. By the surface treatment with hot air, shape adjustment and surface treatment of the obtained classified product can be carried out. The temperature of the hot air is preferably within a range of 100 to 450° C.

The toner base particles may be used as they are as the toner. If necessary, an external additive may be externally added to the surfaces of the toner base particles to form a toner. An example of a method for externally adding the external additive includes a method in which predetermined amounts of the toner base particles and the external additive are blended, and the mixture is stirred and mixed using the mixing device. Examples of the mixing apparatus include a double cone mixer, a V-type mixer, a drum-type mixer, a super mixer, a Henschel mixer, a Nauter mixer, Mechano Hybrid (manufactured by Nippon Coke & Engineering Co., Ltd), and Nobilta (manufactured by Hosokawa Micron Corporation).

### [2-9. Developer]

The toner of the present invention may be used alone as a magnetic or non-magnetic mono-component developer, or may be mixed with carrier particles and used as a two-component developer.

As the carrier particles, for example, magnetic particles formed of a conventionally known material can be used. Examples of the magnetic particles include metals such as iron, ferrite, and magnetic, and alloys of these metals and metals such as aluminum and lead. In particular, ferrite particles are preferable as the carrier particles.

As the carrier particles, coated carrier particles in which the surface of magnetic particles is coated with a coating agent such as a resin, or dispersed carrier particles in which a magnetic fine powder is dispersed in a binder resin may be used. The carrier particles are preferably coated carrier particles from the viewpoint of suppressing adhesion of the carrier particles to the photoreceptor.

The resin for coating is not particularly limited. As the resin for coating, for example, an olefin resin, a styrene resin, a styrene-acrylic resin, a silicone resin, a polyester resin, a fluororesin, or the like can be used. The resin for forming the resin dispersion type carrier is not particularly limited. As such a resin, a known resin can be used. Specifically, for example, an acrylic resin, a styrene-acrylic resin, a polyester resin, a fluorine resin, a phenol resin, or the like can be used.

The volume-based median diameter of the carrier particles is preferably within a range of 20 to 100 μm, and more preferably within a range of 25 to 80 μm. The volume-based median diameter of the carrier particles can be measured with, for example, a laser diffraction particle size distribution analyzer (HELOS, SYMPATEC GmbH) equipped with a wet disperser.

An appropriate amount of the carrier particles may be mixed with the above-described toner particles. Examples of the mixing apparatus to be used for the mixing include a Nauta mixer, a W-shape rotating mixer and a V-shape rotating mixer.

### [3. Fixing Process]

In the fixing process, the first fixing member is brought into contact with the recording medium having the toner image formed thereon, to fix the toner image onto the recording medium. The toner image is formed using the toner according to the present invention described above.

In the fixing step, the heated first fixing member is brought into contact with the recording medium having the toner image formed thereon to heat the toner image, thereby fixing the toner image on the recording medium. Interfaces between the toner particles remain in the toner image before the fixing process. If the interfaces between the toner particles remain even after the fixing step, they become a factor of internal scattering. Therefore, in order to suppress the amount of internally scattered light, it is preferable to sufficiently heat the toner image in the fixing step so that the interfaces between the toner particles do not remain as much as possible. Further, by sufficiently heating the toner image in the fixing step, the uniformity of the image surface is improved.

The first fixing member (first fixer) is a fixing member to be brought into contact with the recording medium. The first fixing member is, for example, the fixing belt. In the fixing step, the fixing pad or a fixing roller for pressing the fixing belt toward the recording medium may be used together with the fixing belt. When the surface of the recording medium to contact the fixing belt is defined as an upper surface, a pressure roller for pressing the recording medium from a lower surface may be further used. In addition, the heating roller for heating the fixing belt may be further used in the fixing step.

In the fixing step, a fixing pad is preferably further used together with the fixing belt that is the first fixing member. Thus, the toner image can be sufficiently heated more easily, and the amount of internally scattered light can be further suppressed. In addition, uniformity of the image surface is easily improved.

The fixing of the toner image in the fixing step may be performed in one stage or in two or more stages. Performing fixing in two or more stages means that the toner image is heated a plurality of times. From the viewpoint of suppressing the amount of internally scattered light by sufficiently heating the toner image, it is preferable to perform fixing in two or more stages, that is, to heat the toner image a plurality of times.

When fixing is performed in two or more stages, different fixing methods may be combined, or the same fixing method may be repeatedly performed. For example, a fixing method using a fixing belt and a fixing pad may be adopted for the first stage, and a fixing method using a fixing belt and a fixing roller may be adopted for the second stage. At this time, the same fixing belt may be used in the first stage and the second stage, or different fixing belts may be used. Alternatively, the toner image may be heated a plurality of times using one fixing device.

An example of the fixing device which can be used in the fixing step will be described.

### (Example 1 of Fixing Device)

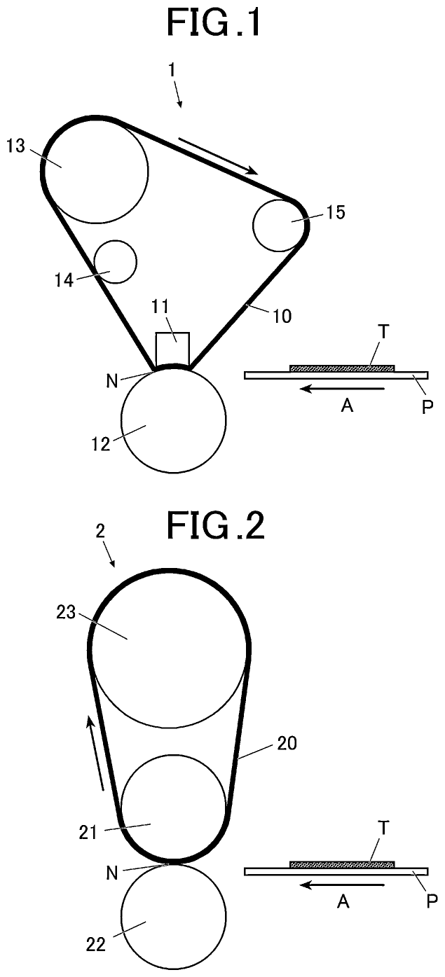

FIG. 1 is a schematic diagram of a fixing device 1 including a fixing belt 10 as the first fixing member. In FIG. 1, an arrow A indicates a conveyance direction of a recording medium P.

In FIG. 1, the recording medium P is conveyed from right to left in the figure. The fixing device 1 includes a fixing pad 11, a pressure roller 12, a heating roller 13, an oil application roller 14, and a steering roller 15 in addition to the fixing belt 10.

The fixing belt 10 is an endless rotatable heating rotator. In the fixing device 1, the fixing belt 10 is the first fixing member that comes into contact with the recording medium P. The fixing belt 10 has thermal conductivity, heat resistance, and the like, and has a thin cylindrical shape. The fixing belt 10 has, for example, a three layer structure including a base layer, an elastic layer positioned on the outer periphery of the base layer, and a release layer positioned on the outer periphery of the elastic layer. The base layer has a thickness of, for example, 60 μm. The material of the base layer is, for example, polyimide resin. The elastic layer has a thickness of, for example, 300 μm. The material of the elastic layer is, for example, silicone rubber. The thickness of the release layer is, for example, 30 μm. The material of the release layer is, for example, PFA (tetrafluoroethylene-perfluoroalkoxyethylene copolymer resin) which is a fluororesin. The fixing belt 10 is stretched by the fixing pad 11, the heating roller 13, and the steering roller 15.

The fixing pad 11 is in pressure contact with the pressure roller 12 via the fixing belt 10 to form a nip portion N having a predetermined width in a conveyance direction of the recording medium P. The fixing pad 11 is a member that has a substantially rectangular cross section and is long along a width direction of the fixing belt 10. The material of the fixing pad 11 needs to be heat-resistant, and for example, liquid crystal polymer (LCP) can be used.

A sliding sheet (not illustrated) whose surface is coated with polytetrafluoroethylene (PTFE) or the like and a lubricant may be interposed between the fixing pad 11 and the fixing belt 10. Thus, the fixing belt 10 can smoothly slide on the fixing pad 11. The lubricant is, for example, silicone oil or grease.

The sliding sheet is formed by, for example, coating a surface of a polyimide base material having a thickness of 70 μm with PTFE. The slide sheet is disposed to improve slidability between the fixing pad 11 and the fixing belt 10. Instead of providing the slide sheet, a coating or the like that improves slidability may be applied to a surface layer of the fixing pad 11.

The pressure roller 12 includes, for example, an elastic layer positioned on the outer periphery of a shaft and a releasing layer positioned on the outer periphery of the elastic layer. The material of the shaft is, for example, stainless steel. The elastic layer has a thickness of, for example, 5 mm. The material of the elastic layer is, for example, conductive silicone rubber. The thickness of the release layer is, for example, 50 μm. The material of the release layer is, for example, PFA (tetrafluoroethylene-perfluoroalkoxyethylene copolymer resin) which is a fluororesin. The pressure roller 12 is rotationally driven.

The heating roller 13 is, for example, a 1 mm thick stainless steel pipe. A halogen heater (not illustrated) is disposed inside the heating roller 13. The halogen heater is capable of generating heat to a predetermined temperature. The fixing belt 10 is heated by the heating roller 13. At this time, the fixing belt 10 is controlled to a predetermined target temperature, for example, based on temperature detection by a thermistor. The heating roller 13 may be configured to be rotationally driven, for example. As the heating roller 13 is rotationally driven, it is possible to increase the tension of the fixing belt 10 from the nip portion N to the heating roller 13 in the rotation direction of the fixing belt 10. Thus, the curvature of the exit of the nip portion N can be increased in the rotation direction of the fixing belt 10, and the separation performance of the recording medium P can be improved.

The oil application roller 14 is formed by, for example, impregnating a roller-shaped member, around which a nonwoven fabric having a thickness of 100 μm is wound, with oil. The oil is, for example, silicone oil. The oil application roller 14 is made to abut on the fixing belt 10 by, for example, a pressing spring (not illustrated). The oil application roller 14 can continuously supply oil to the inner circumferential surface of the fixing belt 10. Thus, a state in which oil is interposed between the fixing belt 10 and the fixing pad 11 is maintained, and stable operation of the fixing device 1 is maintained.

The steering roller 15 suspends the fixing belt 10. The steering roller 15 is supported by, for example, a steering frame (not illustrated). The steering roller 15 changes alignment with respect to other suspension members by the steering frame swinging with the turning shaft as a fulcrum. Thus, a tension difference is generated between front and rear of the fixing belt 10, and a position of the fixing belt 10 is controlled in a width direction of the fixing belt 10. The steering roller 15 may be urged by a spring supported by a steering frame. Thus, the steering roller 15 can also serve as a tension roller that applies a predetermined tension to the fixing belt 10. The axial direction of the turning shafts of the steer frames is the same as the conveyance direction of the recording medium P.

The fixing belt 10 is suspended by the fixing pad 11, the heating roller 13, and the steering roller 15. The fixing belt 10 is pinched by the fixing pad 11 and the pressure roller 12, and is driven to rotate by the pressure roller 12 being rotationally driven. The fixing belt 10 stores heat from the heating roller 13. The recording medium P bearing the unfixed toner image T is nipped and conveyed by the pressure roller 12 and the fixing belt 10 at the nip portion N, and receives heat and pressure required for fixing. Thus, the toner image T is fixed onto the recording medium P.

### Example 2 of Fixing Device

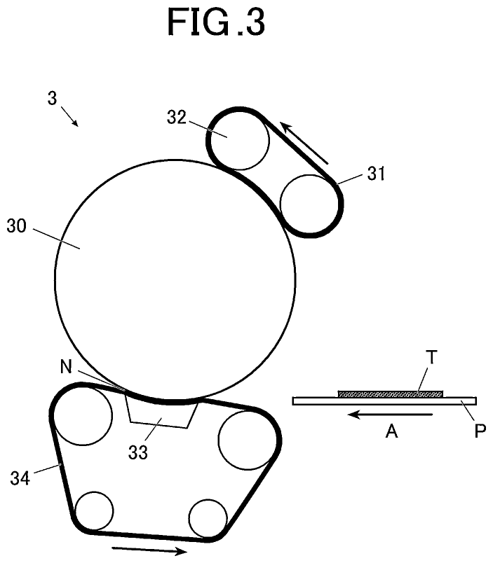

FIG. 2 is a schematic view of a fixing device 2 including a fixing belt 20 as a first fixing member. In FIG. 2, an arrow A indicates a conveyance direction of the recording medium P.

In FIG. 1, the recording medium P is conveyed from right to left in the figure. The fixing device 2 includes a fixing roller 21, a pressure roller 22, and a heating roller 23, in addition to the fixing belt 20.

The fixing roller 21 and the pressure roller 22 cooperatively form a nip portion N for nipping and conveying the recording medium P carrying the toner image T.

The fixing belt 20 is an endless belt. The fixing roller 21 and the heating roller 23 are rotationally driven while stretching the inner surface of the fixing belt 20.

The fixing belt 20 is, for example, a deformable endless belt having a circumferential length 500 mm and a widthwise 340 mm. The fixing belt 20 has a multilayer structure including, for example, a base layer, an elastic layer, and a release layer. The thickness of the base layer is, for example, 70 μm. The material of the base layer is, for example, polyimide resin. The elastic body layer is laminated on an outer peripheral side of the base layer. The thickness of the elastic body is, for example, 200 μm. The material of the elastic body is, for example, silicone rubber. The release layer is laminated on the elastic body layer. The release layer has a thickness of, for example, 30 μm. The material of the release layer is, for example, tetrafluoroethylene-perfluoroalkyl vinyl ether copolymer resin (PFA).

The fixing roller 21 is a hard roller formed of a cylindrical core roller (cored bar) on which a protective layer is formed to prevent metal abrasion of a surface of the core roller. The core roller consists, for example, of outer diameter 60 mm, 360 mm long and 10 mm thick aluminum. The thickness of the protective layer is, for example, 200 μm. The material of the protective layer is, for example, a fluorine resin. The fixing roller 21 is not limited to this configuration. It is sufficient that the fixing roller 21 has a configuration in which substantially no deformation occurs with respect to the pressing force from the pressure roller 22 when the nip portion N is formed between the fixing roller 21 and the pressure roller 22.

The fixing roller 21 may not have a heat source or may have a heat source. The fixing roller 21 receives a driving force from a drive motor (not illustrated) to rotate at a surface speed of, for example, 440 mm/s.

The elastic layer changes the shape of the surface of the fixing belt 20 according to the irregularities of the toner image T formed on the recording medium P, to uniformly supply heat to the entire toner image T. As for the configuration of the fixing belt 20, the material, thickness, hardness, and the like are appropriately selected in accordance with apparatus design conditions such as the purpose of use and use conditions.

The pressure roller 22 is, for example, a soft roller including a base, an elastic layer positioned on the outer periphery of the base, and a release layer positioned on the outer periphery of the elastic layer. The base body is, for example, a cylindrical roller made of aluminum having a diameter of 55 mm and a length of 360 mm. The elastic layer is, for example, 10 mm thick. The material of the elastic layer is, for example, silicone rubber. The thickness of the release layer is, for example, 100 μm. The material of the release layer is, for example, tetrafluoroethylene-perfluoroalkyl vinyl ether copolymer resin (PFA).

The pressure roller 22 is provided in such a manner as to be pressed against the fixing roller 21, and rotates following the fixing roller 21. The surface speed of the rotation of the pressure roller 22 is, for example, the same as the surface speed of the fixing roller 21. The pressure roller 22 may not have a heat source or may have a heat source.

The heating roller 23 is a cylindrical roller formed of, for example, outer diameter 100 mm, 2 mm thick, and 360 mm long aluminum. The heating roller 23 includes a heat source (not illustrated) therein. The heat source is, for example, a halogen heater having a rated 1200 W. Therefore, the heating roller 23 includes a function of stretching the fixing belt 20 and a function of heating the fixing belt 20 from the inner peripheral surface side.

Springs (not illustrated) that press the fixing belt 20 outward may be disposed at both ends of the heating roller 23 in the longitudinal direction. Thus, the heating roller 23 functions to adjust the tensile force of the fixing belt 20 to a predetermined value (e.g., 15 kgf). Furthermore, the heating roller 23 is provided with a belt deviation control mechanism (not illustrated). That is, the heating roller 23 also functions as a steering roller that corrects deviation of the fixing belt 20.

### Example 3 of Fixing Device

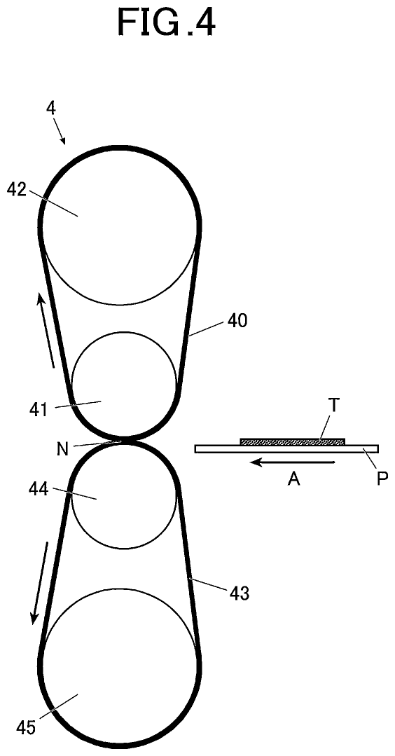

FIG. 3 is a schematic diagram of the fixing device 3 including a fixing roller 30 as the first fixing member. In FIG. 3, an arrow A indicates a conveyance direction of the recording medium P.

In FIG. 3, the recording medium P is conveyed from right to left in the figure. The fixing device 3 includes an external heating belt 31, an external heating roller 32, a fixing pad 33, and a fixing belt 34, in addition to the fixing roller 30.

The fixing roller 30 is heated by the external heating belt 31 heated by the external heating roller 32. The fixing roller 30 forms a nip portion N together with the fixing pad 33 via the fixing belt 34. When the recording medium P on which the toner image T is formed passes through the nip portion N, the toner image T is heated and fixed onto the recording medium P.

### Example 4 of Fixing Device

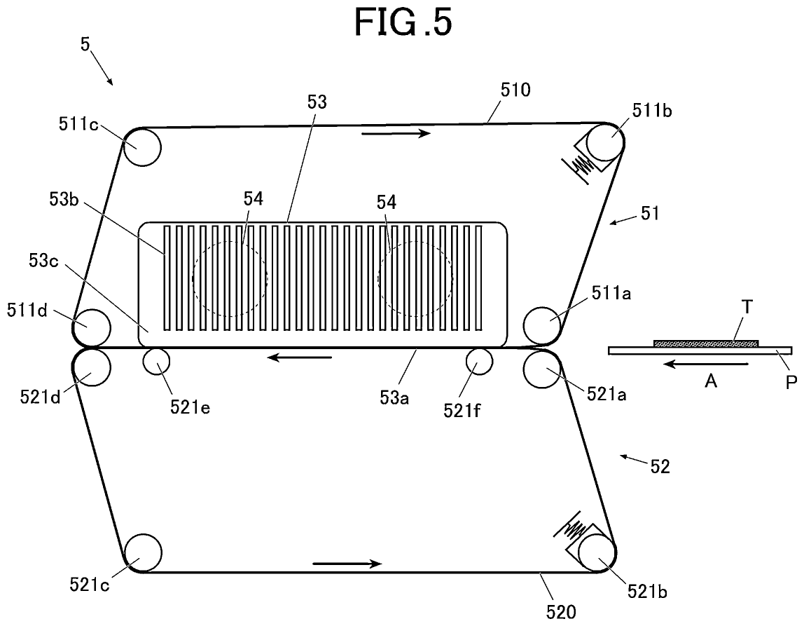

FIG. 4 is a schematic view of a fixing device 4 including a fixing belt 40 as the first fixing member. In FIG. 4, an arrow A indicates a conveyance direction of the recording medium P.

In FIG. 4, the recording medium P is conveyed from right to left in the figure. In addition to the fixing belt 40, the fixing device 4 includes a fixing roller 41, an upper heating roller 42, a pressure belt 43, a pressure roller 44, and a lower heating roller 45.

The fixing belt 40 is heated by the upper heating roller 42. The pressure belt 43 is heated by the lower heating roller 45. The fixing roller 41 and the pressure roller 44 form a nip portion N via the fixing belt 40 and the pressure belt 43. When the recording medium P on which the toner image T is formed passes through the nip portion N, the toner image T is heated and fixed onto the recording medium P.

### [4. Cooling Process]

In the cooling step, the recording medium separated from the first fixing member is cooled. That is, in the image forming method of the present invention, the first fixing member and the recording medium are separated between the fixing step and the cooling step. Cooling the recording medium after separation from the first fixing member allows the toner image to be efficiently cooled with little residual heat. Therefore, the mechanism for cooling the recording medium separated from the first fixing member has a high image cooling rate.

Furthermore, in the cooling process, the first cooling member is brought into contact with the recording medium to cool the recording medium. At this time, it is preferable to cool the toner image by bringing the first cooling member into contact with a portion of the recording medium where the toner image is fixed. The first cooling member (first cooler) is a cooling member that is brought into contact with the recording medium. The first cooling member is, for example, a cooling belt. The mechanism for bringing the first cooling member into contact with the recording medium has high heat conduction efficiency and a high image cooling rate.

A high image cooling rate is effective in decreasing the crystal growth rate to keep the size of the crystallized crystalline polyester domain small. When the size of the crystalline polyester domain is small, the amount of internally scattered light is suppressed, and the color gamut is expanded. Therefore, the present invention including the above-described cooling step in which the image cooling rate is high can form the image having a wide color gamut.

In the cooling step, it is preferable to further use a second cooling member (second cooler) that sandwiches the recording medium together with the first cooling member. By sandwiching the recording medium between the first cooling member and the second cooling member that are in contact with the recording medium, the image cooling rate can be further increased.

The recording medium may be cooled in the following order. (1) is the best; (5) is the worst.
(1) A cooling member is brought into contact with both surfaces of the recording medium to cool the recording medium.
(2) To cool a recording medium by bringing a cooling member into contact with one side of the recording medium. For example, a cooling device including a heat sink on a lower conveyance belt cools one side of the recording medium by a contact method.
(3) The recording medium is cooled by a non-contact method using a cooling fan or the like.
(4) The recording medium is not cooled.

An example of a cooling device that can be used in the cooling step will be described.

### Example 1 of Cooling Device

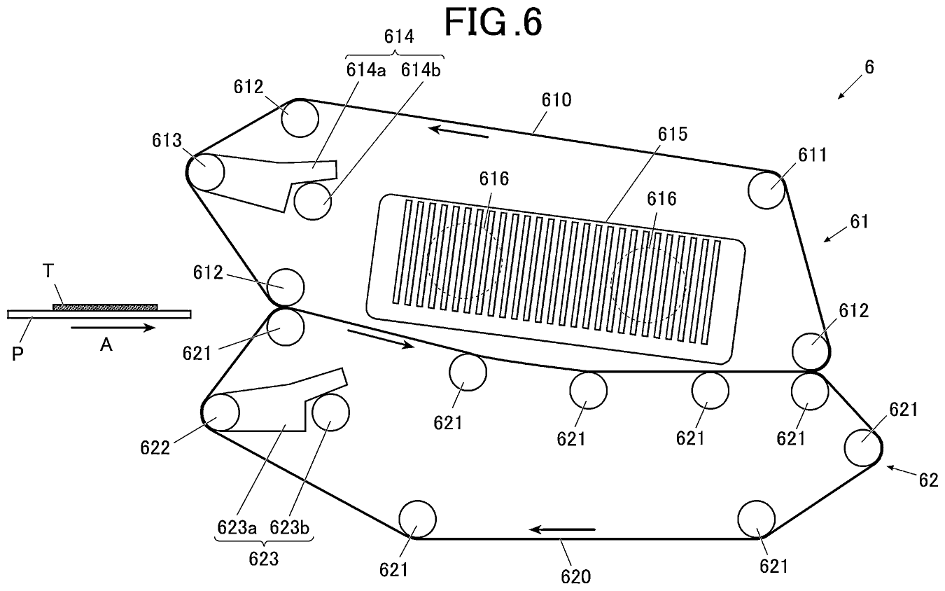

FIG. 5 is a schematic diagram of a cooling device 5 including a first belt 510 as the first cooling member and a second belt 520 as the second cooling member. In FIG. 5, an arrow A indicates a conveyance direction of the recording medium P.

The cooling device 5 is a belt cooling type cooling device. The cooling device 5 includes a first unit 51 and a second unit 52. The first unit 51 includes an endless first belt 510, first belt tension rollers 511a to 511d, and a heat sink 53. The second unit 52 includes an endless second belt 520, second belt tension rollers 521a to 521d, and pressure rollers 521e and 521f. The first belt 510 and the second belt 520 are film-like endless belts formed of, for example, a polyimide resin having high strength.

The first belt 510 is stretched around the plurality of first belt tension rollers 511a to 511d. At least one of the first belt tension rollers 511a to 511d of the first belt 510 is rotated by a drive motor (not illustrated). For example, when the first belt tension roller 511d is rotated by the drive motor, the first belt 510 moves. The first belt tension roller 511d as a driving roller includes, for example, a rubber layer having a thickness 1 mm as a surface layer, and is formed with an outer diameter φ40 mm.

The first belt tension roller 511b is provided so as to be in contact with an inner peripheral surface of the first belt 510 and capable of stretching the first belt 510 together with the first belt tension roller 511c. The first belt tension roller 511b is a steering roller that controls deviation of the first belt 510 in a width direction (a direction of a rotation axis of the first belt tension roller 511c). The first belt tension roller 511b includes, for example, the rubber layer having a 1 mm thickness as a surface layer. The first belt tension roller 511b controls meandering of the first belt 510 by steering control for turning a steering angle with respect to the first belt tension roller 511c.

The second belt 520 is stretched around the plurality of second belt tension rollers 521a to 521d and is made to abut on an outer peripheral surface of the first belt 510. The first belt 510 and the second belt 520 abut against each other to form a nip portion for cooling the recording medium P having the toner image T fixed thereon while nipping and conveying the recording medium P. The second belt tension roller 521d is connected, via a drive gear, to a drive motor (not illustrated) that drives the first belt tension roller 511d. The second belt tension roller 521d rotates by a rotational driving force of the drive motor. Thus, the second belt 520 rotates together with the first belt 510. The second belt tension roller 521b is a steering roller that controls a shift of the second belt 520 in a width direction. The second belt tension roller 521b performs a steering operation of cutting a steering angle with respect to the second belt tension roller 521c with a width-direction central portion as a rotation center, to control meandering of the second belt 520.

Inside the second belt 520, a plurality of pressure rollers 521e and 521f are provided. The plurality of pressure rollers 521e and 521f press the second belt 520 toward the heat sink 53 disposed inside the first belt 510. The pressure rollers 521e and 521f press the second belt 520 with a pressure force of, for example, 4.9 N (0.5 kgf). Thus, the pressure rollers 521e and 521f more surely bring the first belt 510 into contact with the heat sink 53 via the second belt 520.

The recording medium P having the toner image T fixed thereon is nipped by the first belt 510 and the second belt 520 and is conveyed along with the rotation of these belts. At that time, the recording medium P passes through a nip portion formed by contact between the first belt 510 and the second belt 520. Then, the first belt 510 forming the nip portion is cooled by the heat sink 53. The heat sink 53 is in contact with the inner circumferential surface of the first belt 510 at a position where the nip portion is formed, in order to efficiently cool the recording medium P. When the recording medium P passes through the nip portion, its temperature is lowered via the first belt 510 cooled by the heat sink 53.

The heat sink 53 is a heat dissipation plate formed of metal such as aluminum, for example. The heat sink 53 includes a heat absorption portion 53a, a heat dissipation portion 53b, and a fin base 53c. The heat absorption portion 53a is a cooling surface (heat absorbing surface) that comes in contact with the first belt 510 and absorbs heat from the first belt 510 to cool the first belt 510. The heat dissipation portion 53b dissipates heat. The fin base 53c conducts heat from the heat absorption portion 53a to the heat dissipation portion 53b.

The heat dissipation portion 53b is formed of a large number of heat dissipation fins in order to promote efficient heat radiation by increasing a contact area with air taken in from the outside by the cooling fan 54. For example, the heat dissipation fin has 1 mm thickness, 100 mm height, and 5 mm pitch. The fin base 53c is, for example, 10 mm thick.

Here, an example in which both the first belt 510 and the second belt 520 are driven has been described, but the driving method is not limited thereto. For example, only the first belt 510 may be driven, and the second belt 520 may follow the first belt 510. Alternatively, only the second belt 520 may be driven so that the first belt 510 follows the second belt 520. Alternatively, a roller may be used instead of the second belt 520, and may be made to abut on the first belt 510 to form the nip portion.

### Example 2 of Cooling Device

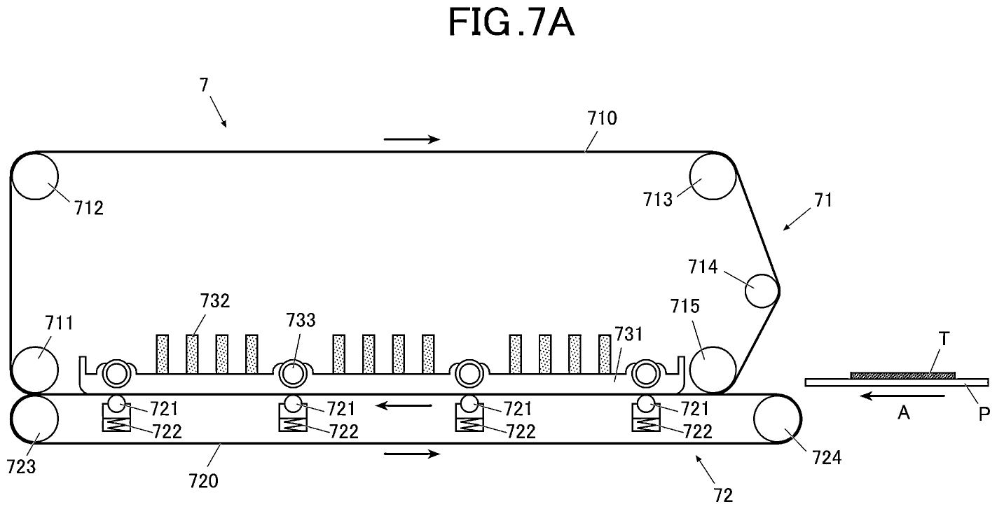

FIG. 6 is a schematic diagram of a cooling device 6 including a heat absorption belt 610 as the first cooling member and a pressing belt 620 as the second cooling member. In FIG. 6, an arrow A indicates a conveyance direction of the recording medium P.

The cooling device 6 includes a heat absorption device 61 and a pressing device 62. The heat absorption device 61 absorbs heat of the recording medium P and the toner image T. The pressing device 62 presses the recording medium P against the heat absorption device 61. The heat absorption device 61 is disposed above the pressing device 62.

The heat absorption device 61 includes a heat absorption belt 610, a driving roller 611, a plurality of winding rollers 612, a steering roller 613, an upper side adjustment mechanism 614, a heat sink 615, and a plurality of fans 616.

The heat absorption belt 610 is annular, and absorbs heat of the recording medium P by coming into contact with the recording medium P. The driving roller 611 transmits a driving force to the heat absorption belt 610. The steering roller 613 corrects meandering of the heat absorption belt 610. The heat absorption belt 610 is wound around the driving roller 611, the plurality of winding rollers 612, and the steering roller 613.

The upper side adjustment mechanism 614 inclines the steering roller 613 with respect to the belt width direction. The upper side adjustment mechanism 614 includes a swing arm 614a, an eccentric cam 614b, and an upper side steering drive section (not illustrated). The eccentric cam 614b is rotationally driven by an upper side steering drive section (not illustrated). The upper side steering drive section rotates the eccentric cam 614b to thereby cause one end side of the swing arm 614a to swing. Thus, the steering roller 613 provided on the other end side of the swing arm 614a is inclined with respect to the width direction of the heat absorption belt 610. For example, when meandering of the heat absorption belt 610 occurs, the steering roller 613 is inclined as described above, so that the meandering of the heat absorption belt 610 is corrected.

The heat sink 615 is provided on an inner peripheral side of the heat absorption belt 610. In FIG. 2, although there is a gap between the heat sink 615 and the heat absorption belt 610, the heat sink 615 is configured to be in contact with the inner peripheral surface of the heat absorption belt 610. Thus, the heat sink 615 dissipates the heat absorbed by the heat absorption belt 610. The heat sink 615 is formed of, for example, an aluminum material.

The fan 616 is disposed on the back side of the heat sink 615. The fan 616 takes heat from the heat sink 615 and discharges hot air to the outside.

The pressing device 62 includes a pressing belt 620, a plurality of winding rollers 621, a steering roller 622, and a lower side adjustment mechanism 623.

The pressing belt 620 is annular and conveys the recording medium P while pressing the recording medium P against the heat absorption belt 610. The steering roller 622 corrects meandering of the pressing belt 620. The pressing belt 620 is looped around the plurality of winding rollers 621 and the steering roller 622.

The lower side adjustment mechanism 623 inclines the pressing belt 620 with respect to the belt width direction. The lower side adjustment mechanism 623 includes a swing arm 623a, an eccentric cam 623b, and a lower side steering drive section (not illustrated). The eccentric cam 623b is rotationally driven by a lower side steering drive section (not illustrated). The lower side steering drive section 24 causes one end side of the swing arm 623b to swing by rotating the eccentric cam 623a. Thus, the steering roller 622 provided on the other end side of the swing arm 623a is inclined with respect to the width direction of the pressing belt 620. For example, in a case where the meandering of the pressing belt 620 occurs, the meandering of the press belt 620 is corrected by tilting the steering roller 622 as described above.

An example of the operation of the cooling device 6 will be described. First, the heat absorption belt 610 rotates by driving of the driving roller 611, and the pressing belt 620 rotates along with the rotation of the heat absorption belt 610. At this time, the heat absorption belt 610 moves while the belt inner circumferential surface thereof is in contact with the heat sink 615. The pressing belt 620 moves while its outer peripheral surface is in contact with the outer peripheral surface of the heat absorption belt 610. At this time, the fan 616 is also operated. Next, the recording medium P on which the toner image T is formed is introduced from an entrance part where the heat absorption belt 610 and the pressing belt 620 start to contact with each other. The introduced recording medium P is conveyed in a state of being sandwiched between the rotating and moving heat absorption belt 610 and pressing belt 620. At this time, the heat of the conveyed recording medium P is absorbed by the heat sink 615 via the heat absorption belt 610, and the recording medium P is cooled. Then, the recording medium P is discharged to the outside of the cooling device 6 from an exit portion where the heat absorption belt 610 and the pressing belt 620 start to separate from each other.

### Example 3 of Cooling Device

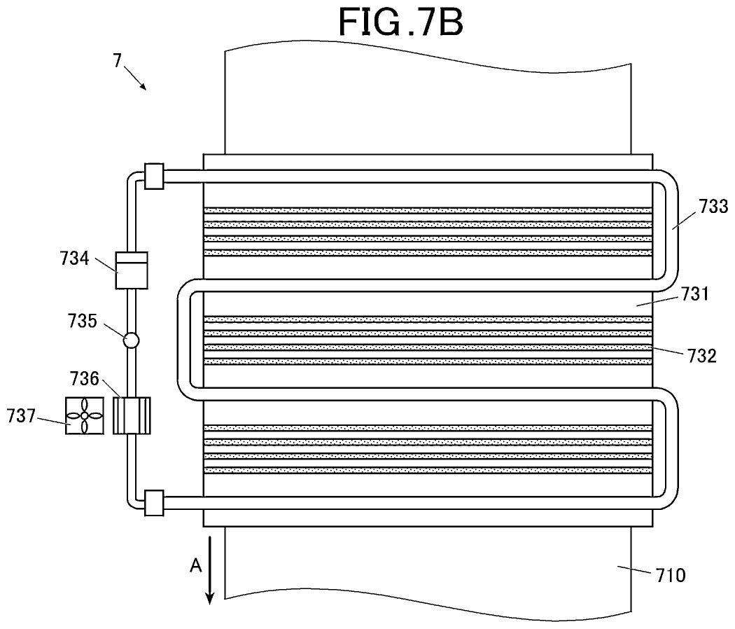

FIG. 7A is a schematic diagram of the cooling device 7 including an upper side conveyance belt 710 as the first cooling member and a lower side conveyance belt 720 as the second cooling member. FIG. 7B is a view of the cooling device 7 when viewed from above. In FIG. 7A and FIG. 7B, an arrow A indicates a conveyance direction of the recording medium P.

The cooling device 7 includes an upper side conveyance unit 71 and a lower side conveyance unit 72.

The upper side conveyance unit 71 includes an upper side conveyance belt 710, a driving roller 711, driven rollers 712, 713, 714, and 715, a cooling plate 731, a heat dissipation fin 732, and a cooling pipe 733.

The lower side conveyance unit 72 is disposed opposite to the upper side conveyance unit 71. The lower side conveyance unit 72 includes a lower side conveyance belt 720, four opposing rollers 721, four pressure members 722, a driving roller 723, and a driven roller 724.

As illustrated in FIG. 7B, the cooling device 7 further includes a liquid storage tank 734, a pump 735, a radiator 736, and a fan 737.

The lower side conveyance belt 720 nips and conveys the recording medium P together with the upper side conveyance belt 710. The opposing roller 721 is provided on the inner side of the lower side conveyance belt 720 and between the driving roller 723 and the driven roller 724. The opposing roller 721 is urged upward by a pressure member 722 provided thereunder to press the lower side conveyance belt 720 against the upper side conveyance belt 710. Each of the four opposing rollers 721 faces the cooling pipe 733 in the up-down direction via the upper side conveyance belt 710 and the lower side conveyance belt 720. The opposing roller 721 is in contact with an inner circumferential surface of the lower side conveyance belt 720. The opposing roller 721 presses the conveyed recording medium P against the vicinity of the cooling pipe 733 of the cooling plate 731. Thus, the cooling device 7 can efficiently cool the recording medium P.

The cooling plate 731 is a member formed of metal having high heat conductivity. A heat-receiving surface of the cooling plate 731 to contact the upper side conveyance belt 710 has a flat plate shape. The cooling plate 731 is provided on the inner side of the upper side conveyance belt 710 and between the driving roller 711 and the driven roller 715. The cooling plate 731 is provided in contact with an inner periphery of the upper side conveyance belt 710. Since the cooling plate 731 extends to the vicinity of the driving roller 711 and the driven roller 715, the recording medium P can be efficiently cooled. The cooling plate 731 is provided with four fitting portions to be fitted to the cooling pipe 733. The fitting portion is formed on a horizontal plane and in a direction orthogonal to the conveyance direction of the recording medium P.

The heat dissipation fin 732 is provided on the cooling plate 731. Specifically, four heat dissipation fins 732 are provided with intervals between the cooling pipes 733. The heat dissipation fin 732 is formed in a direction orthogonal to the conveyance direction of the recording medium P on a horizontal plane. Between the heat dissipation fins 732, there is formed a ventilation path through which an airflow passes along the heat dissipation fins 732. When the cooling plate 731 receives the heat of the recording medium P in a region between adjacent cooling pipes 733, not only the cooling pipes 733 take away the heat, but also the heat dissipation fins 732 release the heat. Thus, the cooling device 7 can efficiently cool the recording medium P.

The cooling pipe 733, the liquid storage tank 734, the pump 735, and the radiator 736 are connected to each other via pipes. These are the channels of the cooling medium.

The cooling pipe 733 is a tubular member formed of metal having high thermal conductivity. The cooling pipe 733 forms a channel of the cooling medium in a direction intersecting the conveyance direction of the recording medium P. The cooling medium contains, for example, water as a main component. The cooling medium may contain propylene glycol or ethylene glycol for lowering the freezing temperature, or a rust inhibitor for preventing rusting of metal parts.

The liquid storage tank 734 is a tank that stores the cooling medium that has passed through the cooling pipe 733.

The pump 735 supplies the cooling medium from the liquid storage tank 734 to the radiator 736. As a result, the cooling medium supplied to the cooling pipe 733 flows from the downstream side to the upstream side in the conveyance direction of the recording medium P. Driving of the pump 735 is controlled by a controller (not illustrated).

The liquid storage tank 734 and the pump 735 are provided at positions where they are not affected by exhaust heat from the fan 737. Thus, the cooling efficiency is improved.

The radiator 736 is a heat dissipation portion that dissipates heat of the cooling medium. The radiator 736 includes a fin (not illustrated) in a channel. When the airflow passes between the fins, the cooling medium in the channel is cooled.

The fan 737 introduces outside air from an opening and guides the outside air to the radiator 736. The fan 737 is disposed on the downstream side of the radiator 736 in the air blowing direction, and rotates so as to draw in an airflow from the radiator 736. Thus, the airflow passes through the radiator 736. The number of fans 737 is not particularly limited.

The operation of the cooling device 7 will be described. First, the upper side conveyance belt 710 and the lower side conveyance belt 720 are brought close to each other. In this state, when the driving roller 711 is rotationally driven, the upper side conveyance belt 710 and the lower side conveyance belt 720 rotate. The recording medium P is conveyed in a direction of an arrow A by rotation of the upper side conveyance belt 710 and the lower side conveyance belt 720. In this state, the pump 735 is driven to circulate the cooling medium in the cooling pipe 733. At this time, the inner surface of the upper side conveyance belt 710 slides on the heat absorption surface of the cooling plate 731. Thus, the cooling plate 731 absorbs heat from the recording medium P via the upper side conveyance belt 710. The cooling medium transports the heat absorbed by the cooling plate 731 to the outside, so that the cooling plate 731 is maintained at a low temperature. The heat absorbed by the cooling medium is radiated to the outside air when the cooling medium passes through the radiator 736. Thus, the temperature of the cooling medium decreases. The low temperature cooling medium flows through the cooling pipe 733 again and absorbs heat from the recording medium P. By repeating this cycle, the recording medium P is cooled.

Modification examples of the cooling device 7 will be described. The cooling device 7 may include three opposing rollers opposed to the three heat dissipation fins 732 in addition to the four opposing rollers 721 opposed to the cooling pipe 733. Thus, the adhesion between the cooling plate 731 and the recording medium P is increased, and the efficiency of cooling the recording medium P is improved.

In the cooling device 7, instead of the upper side conveyance unit 71, the lower side conveyance unit 72 may include the cooling plate 731, the heat dissipation fin 732, and the cooling pipe 733. In this case, the upper side conveyance unit 71 includes the opposing roller 721 and the pressure member 722.

In the cooling device 7, both of the upper side conveyance unit 71 and the lower side conveyance unit 72 may include the cooling plate 731, the heat dissipation fin 732, and the cooling pipe 733. Thus, since the cooling plates 731 are located above and below the recording medium P, the efficiency of cooling the recording medium P is improved.

In the cooling device 7, the channel is not limited to the cooling pipe 733. The channel may be, for example, a channel formed by cutting in the cooling plate 731.

### [5. Image Forming System]

The image forming system according to the present invention includes at least a fixing means and a cooling means. The fixing means is a fixing device that performs the above-described fixing process. The cooling means is a cooling device that performs the above-described cooling process. The image forming system according to the present invention uses the above-described toner of the present invention.

The image forming system according to the present invention may include other units such as a toner image forming unit that forms an unfixed toner image.

The above-described means of the present invention can provide an image forming method and an image forming system that enable formation of an image having high low-temperature fixing ability of an electrostatic charge image development toner and a wide color gamut.

The realization mechanism or action mechanism of the effect of the present invention is not clear, but it is inferred as follows.

As described above, in order to ensure low-temperature fixing ability, it is useful to incorporate a crystalline polyester into the toner. However, a crystalline polyester domain is formed in an image formed with a toner containing a crystalline polyester. The crystalline polyester domain becomes a generation source of internal scattered light. Therefore, even when the dispersibility of the pigment in the image is good, the chroma is decreased due to the internal scattered light caused by the crystalline polyester domain. For this reason, when a toner containing a crystalline polyester is used, it is difficult to form an image having a wide color gamut.

According to the present invention, an image having an expanded color gamut can be formed by suppressing the amount of internally scattered light of the image. In order to suppress the amount of internally scattered light of the image, the present inventor has paid attention to the crystalline polyester domain which may be a generation source of internally scattered light. By keeping the degree of crystallinity of the crystalline polyester in the crystalline polyester domain low, internal scattering in the crystalline region can be made less likely to occur. In addition, internal scattering sources can be reduced by reducing the size of the crystalline polyester domain.

First, the present invention is characterized in that the content of the structural unit derived from a bisphenol A derivative (hereinafter, also referred to as the “BPAD content in APEs”) is 30 mol % or less based on 100 mol % of all the structural units derived from polyhydric alcohols in the amorphous polyester. The structural unit derived from a bisphenol A derivative is an aromatic component and therefore has lower compatibility with the crystalline polyester than an aliphatic component. Therefore, when the content of BPAD in APEs is high, the compatibility between the crystalline polyester and the amorphous polyester decreases. In the present invention, since the content of BPAD in APEs is 30 mol % or less, the compatibility between the crystalline polyester and the amorphous polyester is high. As a result, in the present invention, the crystalline polyester is in a state of being difficult to crystallize, and the degree of crystallinity (the ratio of crystal region) of the crystalline polyester in the crystalline polyester domain tends to be low.

Secondly, the present invention is characterized in that in the cooling step, the cooling member is brought into contact with the recording medium separated from the fixing member to cool the recording medium. Thus, the toner image fixed on the recording medium can be rapidly cooled. The size of the crystalline polyester domain increases through a kinetic process. Therefore, the size of the crystalline polyester domain can be kept small by rapidly cooling the toner image.

A sufficient color gamut is not obtained with only one of the above two features, and an effect is exhibited by combining the above two features.

### EXAMPLES

Hereinafter, the present invention will be specifically described with reference to Examples, but the present invention is not limited thereto. In the following Examples, operations were performed at room temperature (25° C.) unless otherwise specified. In the following Examples, unless otherwise specified, “%” and “parts” mean “% by mass” and “parts by mass”, respectively.

### <Synthesis of Amorphous Polyesters A1 to A12>

The following materials were placed in a reaction vessel equipped with a cooling pipe, a stirrer, a nitrogen inlet tube, and a thermocouple.
Bisphenol A ethylene oxide adduct 0.6 parts by mol
Bisphenol A propylene oxide adduct 29.4 parts by mol
Ethylene glycol 47.0 parts by mol
Propanediol 23.0 parts by mol
Terephthalic acid 82.8 parts by mol
Trimellitic acid 17.2 parts by mol

The reaction vessel was further supplied with 0.5 parts by mass (1.23 parts by mmol) of tin 2-ethylhexanoate as an esterification catalyst. The inside of the reaction vessel was replaced with nitrogen gas. The temperature was gradually raised while stirring the inside of the reaction vessel. While stirring the inside of the reaction vessel at a temperature of 140° C., the mixture was reacted for 3 hours. Next, the pressure in the reaction vessel was lowered to 8.3 kPa, the temperature was raised to 200° C. with stirring and the reaction was carried out for 4 hours. Next, the pressure in the reaction vessel was lowered to 5 kPa or less, and the mixture was reacted at 200° C. for 3 hours. Thus, an amorphous polyester A1 was obtained.

The amorphous polyesters A1 to A12 were synthesized in the same manner as the synthesis of the amorphous polyester A2 except that the alcohol component was changed as listed in Table I.

In Table I, “BPA-EO” represents a bisphenol A ethylene oxide adduct. “BPA-PO” represents a bisphenol A propylene oxide adduct.

TABLE I

| | ALCOHOL COMPONENT [PARTS BY MOL] | | | | | | |
|---|---|---|---|---|---|---|---|
| | BPA- | BPA- | ETHYLENE | | | | |
| | EO | PO | GLYGOL | PROPANEDIOL | BUTANEDIOL | PENTANEDIOL | HEXANEDIOL |
| A1 | 0.6 | 29.4 | 47.0 | 23.0 | — | — | — |
| A2 | 0.3 | 14.7 | 57.0 | 28.0 | — | — | — |
| A3 | 0.2 | 9.8 | [symbol] | 30.0 | — | — | — |
| A4 | [symbol] | 3.92 | [symbol] | 32.0 | — | — | — |
| A5 | — | — | [symbol] | 33.0 | — | — | — |
| A6 | — | — | [symbol] | — | 33.0 | — | — |
| A7 | — | — | [symbol] | — | — | 33.0 | — |
| A8 | — | — | [symbol] | — | — | — | 33.0 |
| A9 | — | — | [symbol] | — | — | — | — |
| A10 | — | — | 100.0 | — | — | — | — |
| A11 | 1.0 | 49.0 | 33.0 | 17.0 | — | — | — |
| A12 | 2.0 | 98.0 | — | — | — | — | — |

| | | ACID COMPONENT | | BPAD |
|---|---|---|---|---|
| | | [PARTS BY MOL] | | CONTENT |
| | ALCOHOL COMPONENT [PARTS BY MOL] | TEREPHTHALIC | TRIMELLITIC | IN APEs |
| | HEPTANEDIOL | ACID | ACID | [MOL %] |
| A1 | — | 82.8 | 17.2 | 30 |
| A2 | — | 82.8 | 17.2 | 15 |
| A3 | — | 82.8 | 17.2 | 10 |
| A4 | — | 82.8 | 17.2 | 4 |
| A5 | — | 82.8 | 17.2 | 0 |
| A6 | — | 82.8 | 17.2 | 0 |
| A7 | — | 62.8 | 17.2 | 0 |
| A8 | — | 82.8 | 17.2 | 0 |
| A9 | 33.0 | 82.8 | 17.2 | 0 |
| A10 | — | 82.8 | 17.2 | 0 |
| A11 | — | 82.8 | 17.2 | 50 |
| A12 | — | 82.8 | 17.2 | 100 |

[symbol]

indicates data missing or illegible when filed

The content of the bisphenol-A derivative-derived structural unit with respect to 100 mol % of the total polyhydric alcohol-derived structural unit (BPAD content in APEs) in the amorphous polyesters A1 to A12 is as shown in Table I.

### <Synthesis of Crystalline Polyesters C1 to C6>

The following materials were placed in a reaction vessel equipped with a cooling pipe, a stirrer, a nitrogen inlet tube, and a thermocouple.
1,6-Hexanediol 60.0 parts by mol
Adipic acid 40.0 parts by mol

The reaction vessel was further supplied with 0.5 parts by mass (1.23 parts by mmol) of tin 2-ethylhexanoate as an esterification catalyst. The inside of the reaction vessel was replaced with nitrogen gas. The temperature was gradually raised while stirring the inside of the reaction vessel. While stirring the inside of the reaction vessel at a temperature of 140° C., the mixture was reacted for 3 hours. Next, the pressure in the reaction vessel was lowered to 8.3 kPa, the temperature was raised to 200° C. with stirring and the reaction was carried out for 1 hour. Thus, an amorphous polyester A1 was obtained.

Crystalline polyesters C2 to C6 were synthesized in the same manner as the crystalline polyester C1 was synthesized, except that the types of the aliphatic polyhydric alcohol component and the aliphatic polycarboxylic acid component were changed as listed in Table II.

TABLE 2

| | ALIPHATIC POLYHYDRIC ALCOHOL | | ALIPHATIC POLYVALENT CARBOXYLIC | |
|---|---|---|---|---|
| | COMPONENT | | ACID COMPONENT | |
| | | CARBON | | CARBON |
| | SUBSTANCE NAME | NUMBER | SUBSTANCE NAME | NUMBER |
| C1 | 1,6-HEXANEDIOL | 6 | ADIPIC ACID | 6 |
| C2 | 1,6-HEXANEDIOL | 6 | SEBACIC ACID | 10 |
| C3 | 1,9-NONANEDIOL | 9 | DODECANEDIOIC ACID | 12 |
| C4 | 1,12-DODECANEDIOL | 12 | SEBACIC ACID | 10 |
| C5 | BUTANEDIOL | 4 | SUCCINIC ACID | 4 |
| C6 | 1,16-HEXADECANEDIOL | 16 | HEXADECANEDIOIC ACID | 16 |

### <Preparation of Cyan Toners 1 to 19>

The following materials were mixed using a Henschel mixer (FM-75 type, manufactured by Mitsui Mining Co., Ltd) at a rotational speed of 20 s⁻¹ for a rotational time of 5 min.
amorphous polyester A1 100 parts by mass
crystalline polyester C1 5 parts by mass
hydrocarbon wax (melting point: 90° C.) 6 parts by mass
Cyan coloring agent (C. I. Pigment Blue 15:3) 7 parts by mass

The obtained mixture was kneaded with a twin-screw kneader (PCM-30 type, manufactured by Ikegai Corporation) set at a temperature of 150° C. The obtained kneaded product was cooled and coarsely pulverized to 1 mm or less with a hammermill to obtain a coarsely pulverized product. The obtained coarsely crushed product was finely pulverized with a mechanical pulverizer (T-250, manufactured by Turbo Kogyo Co., Ltd). The resultant finely pulverized product was classified with a zigzag classifier.

The heat treatment was performed on the classified particles with the surface treatment apparatus under conditions where the temperature of the heat treatment chamber was 150° C. and the treatment time was 30 seconds. Thus, cyan toner base particles 1 having a circularity of 0.96 were obtained.

The following materials were mixed using a Henschel mixer (FM-75 type, manufactured by Mitsui Miike Machinery Co., Ltd) at a rotational speed of 30 s⁻¹ and a rotational time of 10 min.
Cyan toner base particle 1 100.0 parts by mass
Hydrophobic silica fine particles 1.0 parts by mass
Titanium oxide fine particles 1.0 parts by mass
Strontium titanate 0.5 parts by mass

The hydrophobic silica fine particles are hydrophobic silica fine particles hydrophobized with hexamethyldisilazane. A BET specific surface area of the hydrophobic silica fine particles is 200 m²/g. The titanium oxide fine particles are titanium oxide fine particles surface-treated with isobutyltrimethoxysilane. The BET specific surface area of the titanium dioxide fine particles is 80 m²/g.

Coarse particles were removed from the resulting mixture using a sieve having an opening of 45 μm. Thus, a cyan toner 1 was obtained.

Cyan toners 2 to 19 were prepared as in the preparation of cyan toner 1, except that the amorphous polyester and the crystalline polyester were changed as indicated in Table III.

TABLE III

| | | | | CRYSTALLINE POLYESTER | | |
|---|---|---|---|---|---|---|
| | AMORPHOUS POLYESTER | | | | | ALIPHATIC |
| | | | ALIPHATIC | | ALIPHATIC | POLYVALENT |
| | | | POLYHYDRIC | | POLYHYDRIC | CARBOXYLIC |
| | | | ALCOHOL | | ALCOHOL | ACID |
| | | BPAD CONTENT | COMPONENT | | COMPONENT | COMPONENT |
| | | IN APEs | CARBON | | CARBON | CARBON |
| | No. | [MOL %] | NUMBER | No. | NUMBER | NUMBER |
| TONER 1 | A1 | 30 | 2.3 | C1 | 6 | 6 |
| TONER 2 | A2 | 15 | 2.3 | C1 | 6 | 6 |
| TONER 3 | A3 | 10 | 2.3 | C1 | 6 | 6 |
| TONER 4 | A4 | 4 | 2.3 | C1 | 6 | 6 |
| TONER 5 | A5 | 0 | 2.3 | C1 | 6 | 6 |
| TONER 6 | A6 | 0 | 2.4 | C1 | 6 | 6 |
| TONER 7 | A7 | 0 | 2.5 | C1 | 6 | 6 |
| TONER 8 | A8 | 0 | 2.6 | C1 | 6 | 6 |
| TONER 9 | A9 | 0 | 2.7 | C1 | 6 | 6 |
| TONER 10 | A10 | 0 | 2 | C1 | 6 | 6 |
| TONER 11 | A5 | 0 | 2.3 | C2 | 10 | 6 |
| TONER 12 | A5 | 0 | 2.3 | C3 | 9 | 12 |
| TONER 13 | A5 | 0 | 2.3 | C4 | 12 | 10 |
| TONER 14 | A5 | 0 | 2.3 | C5 | 4 | 4 |
| TONER 15 | A5 | 0 | 2.3 | C6 | 16 | 16 |
| TONER 16 | A11 | 50 | 2.3 | C1 | 6 | 6 |
| TONER 17 | A12 | 100 | — | C1 | 6 | 6 |
| TONER 18 | A5 | 0 | 2.3 | — | — | — |
| TONER 19 | A12 | 100 | — | — | — | — |

### <Production of Magenta Toners 1 to 19>

Magenta toners 1 to 19 were produced in the same manner as the cyan toners 1 to 19, respectively, except that the coloring agent was changed to a magenta coloring agent (C. I. Pigment Red 57:1) [12 parts by mass].

### <Preparation of Yellow Toners 1 to 19>

Yellow toners 1 to 19 were produced in the same manner as cyan toners 1 to 19, respectively, except that the coloring agent was changed to a yellow coloring agent (C. I. Pigment Yellow 180) [6 parts by mass].

### <Preparation of Black Toners 1 to 19>

Black toners 1 to 19 were respectively produced in the same manner as the production of the cyan toners 1 to 19 except that the coloring agent was changed to a black coloring agent (carbon black) [8 parts by mass].

### <Preparation of Developer>

Each of the produced toners and a ferrite carrier coated with an acrylic resin and having a volume average particle diameter of 36 μm were mixed so that the toner particle concentration was 6% by mass. In this way, various two-component developers containing various toners were produced.

### <Color Gamut Evaluation>

A multifunction peripheral (manufactured by Konica Minolta, Inc., bizhub PRESS C1070) was modified so that an image (unfixed image) could be collected before the fixing step. The modified machine was used as an unfixed image forming apparatus. POD Gloss Coat 128 (manufactured by Oji Paper Co., Ltd., 128 g/m²) was used as the recording medium. The developer was loaded into the unfixed image forming apparatus. Using the unfixed image forming apparatus, an unfixed image was formed in a default mode. The unfixed image was an image including each of color regions of yellow (Y), magenta (M), cyan (C), red (R), blue (B), and green (G). The pixel ratio of each color region was 100%. The areas of the respective color regions were 2 cm×2 cm.

The fixing step and the cooling step were performed using the fixing devices A to C, the cooling devices D and E, and the fixing and cooling device F in combinations indicated in Table IV. Details of each device are as follows.

### (Fixing Device A)

The fixing device A is obtained by modifying a fixing device taken out from imagePRESS V1000 (manufactured by Canon Inc) so that the fixing device can be driven alone. The fixing device A has the same configuration as the fixing device 1 illustrated in FIG. 1. The fixing device A forms a fixing nip by a non-rotary pressure pad.

### (Fixing Device B)

The fixing device B is obtained by modifying a fixing device taken out from bizhub PRESS C8000 (manufactured by Konica Minolta, Inc) so that the fixing device can be driven alone. The fixing device B is a combination of two fixing devices, and performs fixing in two stages. The fixing device of the first stage has the same configuration as the fixing device 3 illustrated in FIG. 3. The fixing device of the second stage has the same configuration as the fixing device 4 illustrated in FIG. 4.

### (Fixing Device C)

The fixing device C includes the same configuration as the fixing device 2 illustrated in FIG. 2.

### (Cooling Device D)

The cooling device D is obtained by modifying a cooling device taken out from imagePRESS V1000 (manufactured by Canon Inc) so that the cooling device can be driven alone. The cooling device D has the same configuration as the cooling device 5 illustrated in FIG. 5. The cooling device D cools the recording medium by a contact method.

### (Cooling Device E)

The cooling device E is obtained by modifying a cooling device taken out from bizhub PRO C6500 (manufactured by Konica Minolta, Inc) so that the cooling device can be driven alone. The cooling device E cools the recording medium in a non-contact manner.

### (Fixing and Cooling Device F)

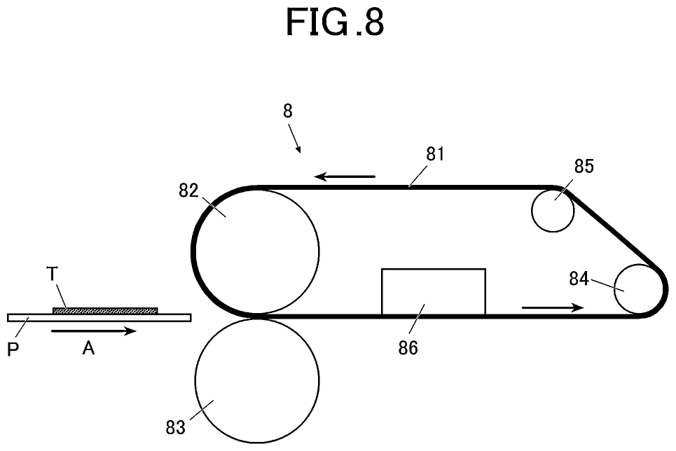

The fixing and cooling device F has the same configuration as the fixing and cooling device 8 illustrated in FIG. 8. The fixing and cooling device 8 includes a fixing and cooling belt 81, a fixing roller 82, a pressure roller 83, winding rollers 84 and 85, and a cooling section 86. The fixing and cooling belt 81 serves as both a fixing belt and a cooling belt. The separation of the recording medium P and the fixing-cooling belt 81 is not performed between the fixing process and the cooling process, but is performed in the vicinity of the winding roller 84. The cooling section 86 cools the recording medium P by a contact method.

In the fixing step using any of the fixing devices, the fixing temperature was 165° C.

The color gamut consisting of Y/M/C/R/G/B of the image after cooling was represented by a*-b* coordinates, and the area was measured as a color gamut area. The color gamut of each image was evaluated using a relative value with the color gamut area of the image of Comparative Example 1 as 100. A fluorescence spectrodensitometer FD-7 (manufactured by Konica Minolta, Inc) was used as a measurement device. The measurement conditions were as follows.

### (Measurement Condition)

light source: D50 light source
Field of View: 2°
Concentration: ANSI T
White reference: Abs
Filter: UV Cut
Measurement Mode: reflectance
Language: Japanese

Based on the relative value of the color gamut, the color gamut was evaluated according to the following criteria. A and B are acceptable levels. The evaluation results are as listed in Table IV.
A: The relative value of the color gamut is 111 or more. (level at which image can be determined as being an extremely high-definition image)
B: The relative value of the color gamut is 101 to 110. (level at which image is felt to be more beautiful than a conventional image)
C: The relative value of the color gamut is 100 or less. (Level equal to or lower than the conventional image)

### <Low-Temperature Fixing Ability Evaluation>

A4 size high-quality paper (NPI high-quality, 127.9 g/m², manufactured by Nippon Paper Industries Co., Ltd) was used as a recording medium. Using the same unfixed image forming apparatus as used in the color gamut evaluation, an unfixed image having a 100 mm×100 mm size was formed under an environment of ordinary temperature and ordinary humidity (temperature of 20° C. and relative humidity of 50%). A developer containing a cyan toner was used. The set value of the adhesion amount of the cyan toner was 11.3 g/m².

The unfixed image was subjected to a fixing test using the same fixing device as that used in the color gamut evaluation. The fixing test was repeatedly performed by changing the fixing temperature from 110° C. to 180° C. in increments of 1° C. In the fixing test, the recording medium was not cooled using the cooling device, but was cooled at room temperature.

The lowest fixing temperature at which image contamination due to fixing offset was not visually observed was defined as the minimum fixing temperature (U.O. avoidance temperature). The low-temperature fixing ability was evaluated according to the following criteria based on the minimum fixing temperature. A, B, and C are acceptable levels. The evaluation results are as listed in Table IV.
A: The minimum fixing temperature is lower than 130° C.
B: The minimum fixing temperature is 130° C. or higher and lower than 135° C.
C: The minimum fixing temperature is 135° C. or higher and lower than 140° C.
D: The minimum fixing temperature is 140° C. or more.

### <Evaluation of Heat Resistance of Toner>

The heat resistance of the produced cyan toner was evaluated by the following method.

The toner particles 0.5 g were placed in a 10 mL glass bottle with a 21 mm inside diameter, which was then closed with a cover and shaken for 600 times at room temperature using a shaker. Tap Denser KYT 2000 (manufactured by Seishin Enterprise Co., Ltd) was used as the shaker. Thereafter, the glass bottle was left in an environment of a temperature of 55° C. and a humidity of 35% RH for 2 hours in a state where the lid was opened. Next, the toner particles were transferred from the glass bottle onto a 48-mesh sieve (opening: 350 μm), taking care not to crush toner aggregates. This was set in a powder tester (manufactured by Hosokawa Micron Corporation) and fixed with a press bar and a knob nut. After the vibration intensity was adjusted to a vibration intensity with 1 mm in a feed width and vibration was applied for 10 seconds, the ratio [% by mass] of the amount of toner remaining on the sieve was measured. The toner aggregation rate was calculated by the following formula (A).

$$toner aggregation rate [ \% ] = ( weight of remaining toner on sieve [ g ] / 0.5 g ) \times 100 \qquad Formula ( A )$$

The same measurement was performed at temperatures of 57.5° C., 60.0° C., and 62.5° C., respectively. A plot was created with temperature on the X-axis and toner aggregation rate on the Y-axis. Among the temperatures of 55° C., 57.5° C., 60.0° C., and 62.5° C., an approximate straight line was drawn between two temperatures sandwiching a region where the toner aggregation rate was 50%. The temperature at which the toner aggregation rate became 50% (hereinafter, also referred to as “50% aggregation temperature”) was calculated by interpolation.

The heat resistance of the toner was evaluated according to the following criteria based on the 50% aggregation temperature. A, B, and C are acceptable levels. The evaluation results are as listed in Table IV.
A: The 50% aggregation temperature is 59° C. or higher.
B: The 50% aggregation temperature is 58° C. or higher and lower than 59° C.
C: The 50% aggregation temperature is 57° C. or higher and lower than 58° C.
D: The 50% aggregation temperature is less than 57° C.

TABLE IV

| | | | | SEPARATION | | | |
|---|---|---|---|---|---|---|---|
| | | | | OF FIXING | | | EVALUATION RESULT |
| | | | | BELT | COOLING | | COLOR [symbol] |
| | TONER | FIXING DEVICE | | BEFORE | DEVICE | | RELATIVE |
| | No. | No. | METHOD | COOLING | No. | METHOD | VALUE |
| EXAMPLE 1 | 1 | A | ONE STAGE | YES | D | CONTACT | 105 |
| | | | (PAD) | | | | |
| EXAMPLE 2 | 2 | A | ONE STAGE | YES | D | CONTACT | 110 |
| | | | (PAD) | | | | |
| EXAMPLE 3 | 3 | A | ONE STAGE | YES | D | CONTACT | 115 |
| | | | (PAD) | | | | |
| EXAMPLE 4 | 4 | A | ONE STAGE | YES | D | CONTACT | 122 |
| | | | (PAD) | | | | |
| EXAMPLE 5 | 5 | A | ONE STAGE | YES | D | CONTACT | 125 |
| | | | (PAD) | | | | |
| EXAMPLE 6 | 6 | A | ONE STAGE | YES | D | CONTACT | 124 |
| | | | (PAD) | | | | |
| EXAMPLE 7 | 7 | A | ONE STAGE | YES | D | CONTACT | 120 |
| | | | (PAD) | | | | |
| EXAMPLE 8 | 8 | A | ONE STAGE | YES | D | CONTACT | 110 |
| | | | (PAD) | | | | |
| EXAMPLE 9 | 9 | A | ONE STAGE | YES | D | CONTACT | 108 |
| | | | (PAD) | | | | |
| EXAMPLE 10 | 10 | A | ONE STAGE | YES | D | CONTACT | 108 |
| | | | (PAD) | | | | |
| EXAMPLE 11 | 11 | A | ONE STAGE | YES | D | CONTACT | 113 |
| | | | (PAD) | | | | |
| EXAMPLE 12 | 12 | A | ONE STAGE | YES | D | CONTACT | 112 |
| | | | (PAD) | | | | |
| EXAMPLE 13 | 13 | A | ONE STAGE | YES | D | CONTACT | 111 |
| | | | (PAD) | | | | |
| EXAMPLE 14 | 14 | A | ONE STAGE | YES | D | CONTACT | 125 |
| | | | (PAD) | | | | |
| EXAMPLE 15 | 15 | A | ONE STAGE | YES | D | CONTACT | [symbol] |
| | | | (PAD) | | | | |
| EXAMPLE 16 | 5 | B | TWO STAGES | YES | D | CONTACT | 124 |
| | | | (PAD, ROLLER) | | | | |
| EXAMPLE 17 | 5 | C | ONE STAGE | YES | D | CONTACT | 102 |
| | | | (ROLLER) | | | | |
| COMPARATIVE | [symbol] | A | ONE STAGE | YES | D | CONTACT | 100 |
| EXAMPLE 1 | | | (PAD) | | | | |
| COMPARATIVE | 17 | A | ONE STAGE | YES | D | CONTACT | [symbol] |
| EXAMPLE 2 | | | (PAD) | | | | |
| COMPARATIVE | 18 | A | ONE STAGE | YES | D | CONTACT | [symbol] |
| EXAMPLE 3 | | | (PAD) | | | | |
| COMPARATIVE | 5 | A | ONE STAGE | YES | E | NON- | [symbol] |
| EXAMPLE 4 | | | (PAD) | | | CONTACT | |
| COMPARATIVE | [symbol] | A | ONE STAGE | YES | E | NON- | [symbol] |
| EXAMPLE 5 | | | (PAD) | | | CONTACT | |
| COMPARATIVE | 17 | A | ONE STAGE | YES | E | NON- | [symbol] |
| EXAMPLE [symbol] | | | (PAD) | | | CONTACT | |
| COMPARATIVE | [symbol] | A | ONE STAGE | YES | E | NON- | [symbol] |
| EXAMPLE [symbol] | | | (PAD) | | | CONTACT | |
| COMPARATIVE | [symbol] | A | ONE STAGE | YES | [symbol] | NON- | [symbol] |
| EXAMPLE [symbol] | | | (PAD) | | | CONTACT | |
| COMPARATIVE | [symbol] | [symbol] | ONE STAGE | NO | F | CONTACT | [symbol] |
| EXAMPLE 9 | | | (PAD) | | | | |

| | EVALUATION RESULT | | | | |
|---|---|---|---|---|---|
| | | LOW-TEMPERATURE | | TONER HEAT | |
| | | FIXING ABILITY | | RESISTANCE | |
| | | MINIMUM | | [symbol] | |
| | | FIXING | | AGGREGATION | |
| | COLOR [symbol] | TEMPERATURE | | TEMPERATURE | |
| | EVALUATION | [° C.] | EVALUATION | [° C.] | EVALUATION |
| EXAMPLE 1 | B | 131 | B | [symbol] | A |
| EXAMPLE 2 | B | [symbol] | A | [symbol] | A |
| EXAMPLE 3 | A | 123 | A | [symbol] | A |
| EXAMPLE 4 | A | 121 | A | [symbol] | A |
| EXAMPLE 5 | A | 120 | A | [symbol] | A |
| EXAMPLE 6 | A | 121 | A | [symbol] | A |
| EXAMPLE 7 | A | 127 | A | [symbol] | A |
| EXAMPLE 8 | B | 129 | A | [symbol] | A |
| EXAMPLE 9 | B | 131 | B | [symbol] | A |
| EXAMPLE 10 | B | 130 | B | [symbol] | A |
| EXAMPLE 11 | A | 124 | A | [symbol] | A |
| EXAMPLE 12 | A | 130 | B | [symbol] | A |
| EXAMPLE 13 | A | 131 | B | [symbol] | A |
| EXAMPLE 14 | A | 120 | A | [symbol] | C |
| EXAMPLE 15 | B | 135 | C | [symbol] | A |
| EXAMPLE 16 | A | 120 | A | [symbol] | A |
| EXAMPLE 17 | B | 133 | B | [symbol] | A |
| COMPARATIVE | D | 135 | C | [symbol] | A |
| EXAMPLE 1 | | | | | |
| COMPARATIVE | D | 137 | C | [symbol] | A |
| EXAMPLE 2 | | | | | |
| COMPARATIVE | D | 145 | D | [symbol] | A |
| EXAMPLE 3 | | | | | |
| COMPARATIVE | D | 120 | A | [symbol] | A |
| EXAMPLE 4 | | | | | |
| COMPARATIVE | D | 150 | D | [symbol] | A |
| EXAMPLE 5 | | | | | |
| COMPARATIVE | D | 137 | C | [symbol] | A |
| EXAMPLE [symbol] | | | | | |
| COMPARATIVE | D | 135 | C | [symbol] | A |
| EXAMPLE [symbol] | | | | | |
| COMPARATIVE | D | 131 | B | [symbol] | A |
| EXAMPLE [symbol] | | | | | |
| COMPARATIVE | D | 121 | A | [symbol] | A |
| EXAMPLE 9 | | | | | |

[symbol]

indicates data missing or illegible when filed

From the above-described results, it can be confirmed that the image forming method of the present invention can form an image having high low-temperature fixing ability of the electrostatic charge image development toner and a wide color gamut.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-184416, filed on Oct. 27, 2023, and Japanese Patent Application No. 2024-053016 filed on Mar. 28, 2024 including description, claims, drawings and abstract is incorporated herein by reference.

What is claimed is:

1. An image forming method that uses an electrostatic charge image development toner containing a toner particle, the image forming method comprising:
bringing a first fixer into contact with a recording medium on which a toner image containing the electrostatic charge image development toner is formed and fixing the toner image on the recording medium; and
cooling the recording medium by bringing a first cooler into contact with the recording medium separated from the first fixer,
wherein the toner particle includes an amorphous polyester and a crystalline polyester, and
wherein a content of a structural unit derived from a bisphenol A derivative is 30 mol % or less based on 100 mol % of all structural units derived from polyhydric alcohols in the amorphous polyester.

2. The image forming method according to claim 1, wherein the content of the structural unit derived from the bisphenol A derivative is 10 mol % or less based on 100 mol % of all the structural units derived from the polyhydric alcohols in the amorphous polyester.

3. The image forming method according to claim 1,
wherein the first fixer is a fixing belt, and
wherein in the fixing, a fixing pad is further used.

4. The image forming method according to claim 3, wherein in the fixing, fixing is performed in one stage.

5. The image forming method according to claim 3, wherein the toner image is heated a plurality of times in the fixing.

6. The image forming method according to claim 1, wherein the amorphous polyester includes a structural unit derived from an aliphatic polyhydric alcohol having 3 to 6 carbon numbers.

7. The image forming method according to claim 1, wherein the crystalline polyester includes a structural unit derived from an aliphatic polyhydric alcohol having 6 to 12 carbon numbers and a structural unit derived from an aliphatic polycarboxylic acid having 6 to 12 carbon numbers.

8. The image forming method according to claim 1, wherein in the cooling, a second cooler that sandwiches the recording medium together with the first cooler is further used.

9. An image forming system that uses an electrostatic charge image development toner containing a toner particle, the image forming system, comprising:
a fixing unit that brings a first fixer into contact with a recording medium on which a toner image containing the electrostatic charge image development toner is formed and that fixes the toner image on the recording medium; and
a cooling unit that cools the recording medium by bringing a first cooler into contact with the recording medium separated from the first fixer,
wherein the toner particle includes an amorphous polyester and a crystalline polyester, and
wherein a content of a structural unit derived from a bisphenol A derivative is 30 mol % or less based on 100 mol % of all structural units derived from polyhydric alcohols in the amorphous polyester.
